(19) United States
(12) Patent Application Publication
(10) Pub. No.: US 2018/0088493 A1
(43) Pub. Date: Mar. 29, 2018

(54) DEVICES AND METHODS FOR REMANUFACTURING TONER PRINTER CARTRIDGES

(71) Applicant: MITSUBISHI KAGAKU IMAGING CORPORATION, Glendale, CA (US)

(72) Inventors: Craig RUMMLER, Torrance, CA (US); Shinichi IIJIMA, San Marino, CA (US); Mark DRAKE, Simi Valley, CA (US); Valeriy KISELEV, Pasadena, CA (US); Manuel NUNEZ, Sylmar, CA (US); Carlos GORDON, Inglewood, CA (US); Gerardo MARTINEZ, Glendale, CA (US)

(73) Assignee: MITSUBISHI KAGAKU IMAGING CORPORATION, Glendale, CA (US)

(21) Appl. No.: 15/566,613

(22) PCT Filed: Mar. 14, 2016
(86) PCT No.: PCT/US16/22344

§ 371 Date: Oct. 13, 2017

Related U.S. Application Data
(60) Provisional application No. 62/133,097, filed on Mar. 13, 2015.
(60) Provisional application No. 62/142,707, filed on Apr. 3, 2015.
(60) Provisional application No. 62/154,214, filed on Apr. 29, 2015.

(51) Int. Cl. G03G 15/08

(52) U.S. Cl. CPC G03G 15/0894; G03G 15/0882; G03G 21/181; G03G 15/0863; G03G 15/0874

(57) ABSTRACT

The invention provides devices and methods for remanufacturing toner printer cartridges and their components by reusing a seal for the toner opening port. The invention also provides devices and methods for remanufacturing a printer cartridge by resealing the toner opening port of the toner hopper. The invention also relates to devices and methods to install and replace seals on a toner hopper, refill toner in a toner hopper, replace a bag of toner in a toner hopper, and replace a chip for a toner cartridge. Also included are devices and methods of sealing a toner cartridge and reattaching a toner cartridge end cap to a waste hopper. A soft shell bottle suitable for use in a toner cartridge composed of a soft polymeric material is also provided.

### CONTINUING APPLICATION INFORMATION

The present application claims benefit of the filing dates of U.S. Provisional Application Ser. Nos. 62/154,214, 62/133,097 and 62/142,707, filed on Apr. 29, 2015, Mar. 13, 2015 and Apr. 3, 2015, respectively, each of which is incorporated herein by reference.

### BACKGROUND OF THE INVENTION

### 1. Field of the Invention

The present invention relates to electrophotography and devices and methods for remanufacturing toner printer cartridges and their components. The invention particularly relates to devices and methods to reuse seals on a toner hopper. The also relates to devices and methods to access the internal area of a printer cartridge to replace seals on toner hoppers. The invention also relates to devices and methods to install and replace seals on a toner hopper, refill toner in a toner hopper, replace a bag of toner in a toner hopper, and replace a chip for a toner cartridge. The invention also relates to devices and methods for sealing a toner cartridge and reattaching a toner cartridge end cap to a waste hopper. A soft shell bottle suitable for use in a toner cartridge composed of a soft polymeric material is also provided.

### 2. Description of the Background

Printer cartridges, such as toner cartridges, are used in various electrophotographic imaging devices, such as laser printers, copiers, facsimile machines, and multifunction imaging devices. Once original equipment manufacturer (OEM) printer cartridges are used, they are often recycled and remanufactured. The process of remanufacturing a printer cartridge may include cleaning the cartridge, repairing damaged parts, replacing worn parts, reassembling with new parts, and replenishing the cartridge with toner. The process of remanufacturing a printer cartridge requires that the printer cartridge be disassembled to repair and/or reassemble for subsequent use.

The toner that is used by the printer cartridge to form an image is stored in a toner hopper. Toner is usually added into the printer cartridge by pouring toner into the toner hopper via a toner opening port. During or after remanufacturing, the toner opening port must be sealed so that toner will not leak from the toner hopper during shipment or before the cartridge is used. There is a need for methods and devices to improve these seals to prevent toner from leaking from the toner hopper.

Until recently, printer cartridges contained toner exit ports through which toner opening ports could be accessed. Seals could be inserted through existing toner exit ports, which are openings that are adjacent to the toner opening ports and that lead to the toner opening ports. In some cartridges, toner exit port plugs are used to cover and prevent toner leakage around the toner exit ports.

Newer models of toner cartridges, such as those made for the Hewlett Packard Corporation HP-M553 family of laser printers, contain toner hoppers that are formed by a top closure and a bottom vessel for toner. As depicted in FIGS. 1A and 1B, the top closure and bottom vessel are welded shut. The printer cartridges also contain seals affixed to the toner opening port of the toner hopper to further prevent toner from leaking. These seals are attached via a tab connected to the seal to the toner agitator inside the toner hopper. After the cartridge is installed into the printer, the agitator rotates, pulling the tab of the seal, opening the toner opening port, and allowing the toner to flow out of the toner hopper. Once the seal is pulled from the toner opening port, the seal is either wrapped around the agitator or disposed in the toner hopper.

In addition, other newer models of toner cartridges, such as those made for the Hewlett Packard Corporation HP-M252 and HP-M552 families of laser printers, do not contain toner exit ports. These printer cartridges contain seals that are welded to the toner hopper to close the toner opening port. The seals are removed once the cartridge is used by the printer and stored in the toner hopper. One difficulty encountered in remanufacturing printer cartridges is accessing the components and parts inside. Without exit ports, the interior of the cartridge cannot be accessed to insert a new seal and remanufacture the printer cartridge. Specifically, there is a need for methods and devices to access the toner opening port of the toner hopper to install a replacement seal.

In addition, newer models of toner cartridges, such as those made for the Hewlett Packard Corporation HP-M252, HP-M552, and HP-M277 families of laser printers, contain seals that are welded to the toner hopper to close the toner opening port. As shown in FIGS. 15-21, the toner in these printer cartridges is stored in a sealed bag inside of the toner hopper. The bag of toner is opened once the cartridge is used by the printer and stored in the toner hopper. The bag of toner has holes cut in it that are attached to posts inside the toner hopper. The bag of toner has a seal strip that attached to the bag of toner and seals the bag shut. The bag of toner is attached via the seal strip to the toner agitator inside the toner hopper. After the cartridge is installed into the printer the agitator rotates and pulls the seal strip, opening the bag and allowing the toner to flow from the bag into the toner hopper. There is a need for methods and devices to replace these bags of toner.

These newer models of toner cartridges also include chips that are kept in place by a toner hopper end cap that is sonically welded to a waste hopper. Breaking the sonic weld would cause damage to the waste hopper. As depicted in FIGS. 28-33, the original chip is disposed in a housing with a fin that prevents it from sliding out. There is a need for methods and devices to replace these chips without damaging the waste hopper.

### SUMMARY OF THE INVENTION

The present invention as described herein s directed to four general embodiments as follows:

(1) methods and devices to reuse seals on a toner hopper,

(2) methods and devices to access the internal area of a printer cartridge to replace seals on toner hoppers,

(3) methods and devices to install and replace seals on a toner hopper, refill toner in a toner hopper, replace a bag of toner in a toner hopper, and replace a chip for a toner cartridge, and

(4) methods and devices and methods of sealing a toner cartridge and reattaching a toner cartridge end cap to a waste hopper, as well as a soft shell bottle suitable for use in a toner cartridge composed of a soft polymeric material,

### Embodiment (1)

In one embodiment, the present invention provides a method fir sealing a toner hopper of a printer cartridge, comprising:

collecting a seal from a toner hopper; and

disposing the seal over a toner opening port of the toner hopper.

In another embodiment of the invention, the seal is a film.

In another embodiment of the invention, the seal comprises a tab.

In another embodiment of the invention, the method further comprises attaching the tab to an agitator in the toner hopper.

In another embodiment of the invention, the method further comprises affixing a gasket to the perimeter of the toner opening port of the toner hopper.

In another embodiment of the invention, the method further comprises affixing the seal to the gasket.

In another embodiment of the invention, the gasket includes at least one adhesive layer.

In another embodiment of the invention, the method further comprises affixing a gasket to the perimeter of the top of a bottom vessel of a toner hopper.

In another embodiment of the invention, the gasket includes at least two adhesive layers.

In another embodiment of the invention, the method further comprises sealing the toner hopper with a top holder.

In another embodiment of the invention, the adhesive layers are on opposite sides of the gasket.

### Embodiment (2)

In one embodiment, the present invention provides a method for resealing a toner hopper of a printer cartridge, comprising:

accessing an internal area of the printer cartridge;

inserting a seal into the internal area of the printer cartridge; and

affixing the seal on the toner hopper.

In another embodiment of the invention, the internal area of the toner cartridge is accessed by cutting a hole in a wall of the printer cartridge.

In another embodiment of the invention, the seal is affixed to the toner opening port of the toner hopper.

In another embodiment of the invention, the seal is affixed with an adhesive.

In another embodiment of the invention, the seal is affixed with heat.

In another embodiment of the invention, the method comprises removing debris created by cutting the hole.

In another embodiment of the invention, the hole is made in optimal position.

In another embodiment of the invention, the optimal position is a wall of the printer cartridge adjacent to the toner opening port of the toner hopper.

In another embodiment of the invention, the optimal position is not on a seam of the printer cartridge.

In another embodiment of the invention, the cutting is performed by sawing.

In another embodiment of the invention, the cutting is performed by drilling.

In another embodiment of the invention, the method comprises aligning a guide with the printer cartridge.

In another embodiment of the invention, the method comprises aligning a guide with the printer cartridge to determine the optimal position for the hole.

In another embodiment of the invention, the method comprises removing a used seal from the toner hopper.

In another embodiment of the invention, the method comprises adding toner to the toner hopper.

In another embodiment of the invention, the method comprises inserting a replacement seal through the hole.

In another embodiment of the invention, the hole is made by a tool.

In another embodiment of the invention, the tool comprises a rotary bit.

In another embodiment of the invention, the tool is a Dremel tool.

In another embodiment of the invention, the tool comprises an attachment to collect debris.

In one embodiment, the present invention also provides a method of creating a guide to determine the optimal placement of a hole in a wall of a second printer cartridge, comprising:

aligning the guide against a printer cartridge with a hole; and

marking the guide to indicate the placement of the hole on the printer cartridge.

In another embodiment of the invention, the guide is used to determine where to cut a hole in a second printer cartridge.

In another embodiment of the invention, the guide is used to cut a hole in a wall of a second printer cartridge.

In another embodiment, the present invention provides a method of creating a guide to determine the optimal placement of a hole in a wall of a printer cartridge, comprising:

measuring the dimensions of the printer cartridge;

determining the optimal placement of a hole in the wall of the printer cartridge; and

preparing a guide incorporating the dimensions of the printer cartridge and the optimal placement of a hole in the wall of the printer cartridge,

In another embodiment of the invention, the method comprises aligning the guide with a printer cartridge.

In another embodiment of the invention, the method comprises using the guide to cut a hole in the wall of a printer cartridge.

In another embodiment, the present invention provides an apparatus for accessing the inside of a toner cartridge comprising a cutting tool.

In another embodiment of the invention, the apparatus comprises a tool that inserts a seal into the internal area of the toner cartridge.

In another embodiment of the invention, the apparatus comprises a tool that affixes a seal on the toner hopper.

In another embodiment of the invention, the cutting tool comprises a rotary bit.

In another embodiment of the invention, the cutting tool is a Dremel tool.

In another embodiment, the present invention also provides a method of sealing a toner opening port of a printer cartridge, comprising:

cutting a hole in the wall of a toner printer cartridge to access an internal area of the printer cartridge, the hole being cut to lead to the toner opening port of the toner hopper;

inserting a seal through the hole into the internal area of the printer cartridge; and

affixing the seal on the toner hopper to cover the toner opening port of the toner hopper.

### Embodiment (3)

In one embodiment, the present invention provides a method for sealing a toner hopper of a printer cartridge comprising:

disposing a seal over a toner opening of the toner hopper, and on top of a doctor blade and a retaining blade.

In another embodiment of the invention, the seal is a film.

In another embodiment of the invention, the seal comprises a pull tab.

In another embodiment of the invention, the seal is made of anti-static material.

In another embodiment, the present invention provides a method of removing a bag of toner from a toner hopper, comprising:

accessing an internal area of the printer hopper; and

removing the bag of toner.

In another embodiment, the present invention provides a method of replacing a bag of toner in a toner hopper, comprising:

accessing an internal area of the printer hopper;

removing the bag of toner; and

inserting a replacement bag of toner.

In another embodiment of the invention, the internal area of the toner hopper is accessed by cutting a hole in a wall of the toner hopper.

In another embodiment of the invention, the bag of toner is removed through the hole.

In another embodiment of the invention, the method further comprises filling the replacement bag of toner with toner.

In another embodiment of the invention, the replacement bag of toner is filled before it is inserted in the toner hopper.

In another embodiment of the invention, the replacement bag of toner is filled after it is inserted in the toner hopper.

In another embodiment of the invention, the hole is filled.

In another embodiment of the invention, the method further comprises sealing the hole.

In another embodiment of the invention, the hole is sealed by replacing the material that was removed to access the internal area of the printer hopper.

In another embodiment of the invention, the material is melted shut.

In another embodiment of the invention, the material is welded shut.

In another embodiment of the invention, the method comprises removing debris created by cutting the hole.

In another embodiment of the invention, the hole is made in an optimal position.

In another embodiment of the invention, the optimal position is a wall of the printer cartridge adjacent to the toner opening port of the toner hopper.

In another embodiment of the invention, the optimal position is not on a seam of the printer cartridge.

In another embodiment of the invention, the cutting is performed by sawing.

In another embodiment of the invention, the cutting is performed by drilling.

In another embodiment of the invention, the method comprises adding toner o the toner hopper.

In another embodiment of the invention, the hole is made by a tool.

In another embodiment of the invention, the tool comprises a rotary bit

In another embodiment of the invention, the tool is a Dremel tool.

In another embodiment of the invention, the tool comprises an attachment to collect debris.

In another embodiment of the invention, the replacement bag of toner includes an adhesive to adhere the bag to the inside of the toner hopper.

In another embodiment of the invention, the replacement bag of toner includes a liner.

In another embodiment of the invention, the method further comprises removing the liner to expose the adhesive.

In another embodiment of the invention, the method further comprises adhering the replacement bag of toner to the inside of the toner hopper.

In another embodiment of the invention, the replacement bag of toner includes a string to attach the hag to an agitator in the toner hopper.

In another embodiment of the invention, the method further comprises attaching the string to the toner hopper agitator

In another embodiment, the present invention provides a replacement bag of toner, comprising:

an adhesive to adhere the bag to the inside of a toner hopper; and

a string to attach the bag to an agitator in the toner hopper.

In another embodiment of the invention, the bag is perforated.

In another embodiment, the present invention provides a method for replacement a chip for an image forming device, comprising:

accessing a chip by removing the fin; and

replacing the chip.

In another embodiment of the invention, the method further comprises securing the chip.

In another embodiment of the invention, the chip is secured by replacing the fin.

In another embodiment of the invention, the chip is secured with an adhesive.

In another embodiment of the invention, the chip is secured with heat.

In another embodiment of the invention, the chip is secured by welding it to the cartridge.

### Embodiment (4)

In one embodiment, the present invention relates to a method of sealing a toner cartridge, comprising:

removing a supply roller through a hole in the side of a toner hopper of a toner cartridge;

placing a seal onto a seal area of the toner hopper;

installing a pull strip portion of the seal through the hole in the side of the toner hopper; and

installing a supply roller plug in the hole in the side of the toner hopper,

wherein the supply roller plug contains (1) a notched portion adapted to receive a supply roller and (2) a seal exit port.

In another embodiment of the invention, the supply roller plug is composed of plastic or rubber.

In another embodiment of the invention, the supply roller plug is adhered to the toner hopper with adhesive or glue.

In another embodiment, the present invention also provides a toner hopper comprising a supply roller, wherein the toner hopper has a hole in a side thereof through which the supply roller can be removed from the toner hopper.

In another embodiment of the invention, the hole is covered with a supply roller plug.

In another embodiment of the invention, the supply roller plug contains (1) a notched portion adapted to receive a supply roller and (2) a seal exit port.

In another embodiment of the invention, the supply roller plug is composed of plastic or rubber.

In another embodiment, the present invention provides a supply roller plug composed of plastic or rubber and containing (1) a notched portion adapted to receive a supply roller and (2) a seal exit port, wherein the supply roller plug is adapted to fit into a hole in the side of a toner hopper.

In another embodiment, the present invention also provides a method of reattaching a toner cartridge end cap to a waste hopper, comprising:

drilling a hole in a waste hopper and a toner cartridge end cap attached to the waste hopper;

removing the toner cartridge end cap from the waste hopper;

reattaching the toner cartridge end cap to the waste hopper with a screw clip having holes to accept a screw; and

installing a screw through the toner cartridge end cap, waste hopper and screw clip to secure the toner cartridge end cap to the waste hopper.

In another embodiment, the present invention also provides a soft shell bottle suitable for use in a toner cartridge composed of a soft polymeric material,

wherein the bottle has a body with a plurality of holes and

wherein the body has a plurality of protrusions which are adapted to come into contact with the flaps of an agitator of a toner cartridge.

In another embodiment of the invention, the polymeric material comprises at least one member selected from the group consisting of polypropylene, polyethylene and polyethylene terephthalate.

In another embodiment of the invention, the bottle has a substantially cylindrical shape.

In another embodiment of the invention, the bottle has at least one open end which is fitted with an end cap.

In another embodiment of the invention, the bottle contains a toner.

### BRIEF DESCRIPTION OF THE DRAWINGS

The invention can be better understood with reference to the following detailed description taken in conjunction with the accompanying drawings which illustrate preferred and exemplary embodiments, but which are not necessarily drawn to scale, wherein:

FIG. 1A shows a bottom perspective view of a sealed printer cartridge;

FIG. 1B shows a side perspective view of a sealed printer cartridge;

FIG. 2A shows a side perspective view of a sealed printer cartridge being opened with a tool;

FIG. 2B shows a side perspective view of an opened printer cartridge;

FIG. 2C shows a top internal view of an opened printer cartridge;

FIG. 3A shows a side perspective view of a seal attached to a toner hopper;

FIG. 3B shows a close up view of a seal attached to a toner hopper;

FIG. 4A shows a close up view of a tab of a seal;

FIG. 4B shows a close up view of a tab attached to an agitator;

FIG. 5A shows a top perspective view of a toner hopper identifying an area around the periphery of the top of the bottom vessel of the toner hopper on which to apply a bonding agent or method;

FIG. 5B shows a close up view of the top side of the bottom vessel of the toner hopper;

FIG. 6 shows a top perspective view of the bottom vessel of the toner hopper identifying an area around the periphery of the bottom vessel on which to apply a bonding agent or method;

FIG. 7 shows a top perspective view of a toner hopper of a printer cartridge sealed by an OEM;

FIG. 8 shows an internal perspective view of a toner hopper of a printer cartridge sealed by an OEM of FIG. 7;

FIG. 9 shows a side perspective view of a toner hopper of a printer cartridge welded closed by an OEM of FIG. 7;

FIG. 10 shows a side perspective view of a printer cartridge which does not allow access to the toner hopper;

FIG. 11 shows a side perspective view of a printer cartridge with a hole allowing a seal to be inserted;

FIG. 12 shows a side perspective view of a printer cartridge with seal being inserted through the hole to be applied to the toner hopper;

FIG. 13 shows a top perspective view of a printer cartridge with seal being inserted through the hole to be applied to the toner hopper;

FIG. 14 shows a cross-sectional view of a printer cartridge with a seal disposed in the printer cartridge and depicting a method for removing an inserted seal;

FIG. 15 shows an internal view of the OEM designed toner hopper of a printer cartridge that contains a bag of toner;

FIG. 16 shows an alternate internal view of the OEM designed toner hopper of a printer cartridge that contains a bag of toner;

FIG. 17 shows the OEM designed bag of toner that has holes cut in it that are attached to posts inside the toner hopper;

FIG. 18 shows the top perspective view of the OEM designed bag of toner that has a seal strip that is attached to the bag of toner using hot melt process;

FIG. 19 shows a close up view of the OEM designed seal strip of the bag of toner;

FIG. 20 shows a top perspective view of the OEM designed bag of toner attached by its seal strip to the agitator of the toner hopper;

FIG. 21 shows a top perspective view of the OEM designed bag of toner after it has been installed in the printer, the agitator has rotated, pulled off the seal, and opened the hag, allowing toner to flow from the bag of toner into the toner hopper;

FIG. 22 shows a side view of a toner cartridge identifying a potential area to access the inside of the toner hopper;

FIG. 23 shows a side view of a toner cartridge with a hole in it to access the inside of the toner hopper;

FIG. 24 shows a side view of a toner cartridge with a hole in it through which a bag of toner is being removed;

FIG. 25 shows a replacement bag of toner to be installed in the toner hopper;

FIG. 26 shows the insertion of a replacement bag of toner into the toner hopper;

FIG. 27 shows another view of the insertion of a replacement bag of toner into the toner hopper;

FIG. 28 shows a top perspective view of the chip held in place by the toner cartridge;

FIG. 29 shows a side perspective view of the chip held in place by the toner cartridge;

FIG. 30 shows an alternate side perspective view of the chip held in place by the toner cartridge;

FIG. 31 shows a side perspective view of the chip held in place by the toner cartridge and a fin that prevents the chip from sliding out of the end cap;

FIG. 32 shows an alternate side perspective view of the chip held in place by the toner cartridge and a fin that prevents the chip from sliding out of the end cap;

FIG. 33 shows a side perspective view of the chip set inside the chip housing;

FIG. 34 shows a side perspective view of the chip with the fin;

FIG. 35 shows an alternate side perspective view of the chip with the fin removed;

FIG. 36 shows an alternate side perspective view of the chip with the fin removed;

FIG. 37 shows the shaft of the supply roller fits through a hole in the plastic plug;

FIG. 38 shows the plug removed from the toner hopper;

FIG. 39 shows removal of the supply roller from the toner hopper;

FIG. 40 shows placing a seal onto the seal area on the outside of the toner hopper;

FIG. 41 shows installing the pull strip portion of the seal through the hole used to install the supply roller;

FIG. 42 shows a supply roller plug which contains a notched portion to receive the supply roller axle and a seal exit port;

FIG. 43 shows a cartridge end cap;

FIG. 44 shows a preferred spot for drilling a hole through the end cap and the waste hopper;

FIG. 45 shows breaking the sonic weld freeing the end cap from the waste hopper;

FIG. 46 shows a screw clip designed so that a threaded screw can be secured through the top portion of the clip and also has a hole which allows a screw to be installed through the screw clip;

FIG. 47 shows a waste hopper;

FIG. 48 shows the cartridge end cap reattached to the waste hopper by the screw clip and a screw; and

FIG. 49 shows the soft shell bottle of the present invention. Panel (1) shows a bottle having a substantially cylindrical shape. The body has a plurality of holes, where the holes are covered with a seal. The body of the bottle also has a plurality of protrusions which are adapted to interact with the flaps of an agitator. The bottle n be inserted into a toner cartridge and the seal covering the holes on the body of the bottle can be removed when the cartridge is to be used. Panel (2) shows the bottle equipped win end caps and a seal.

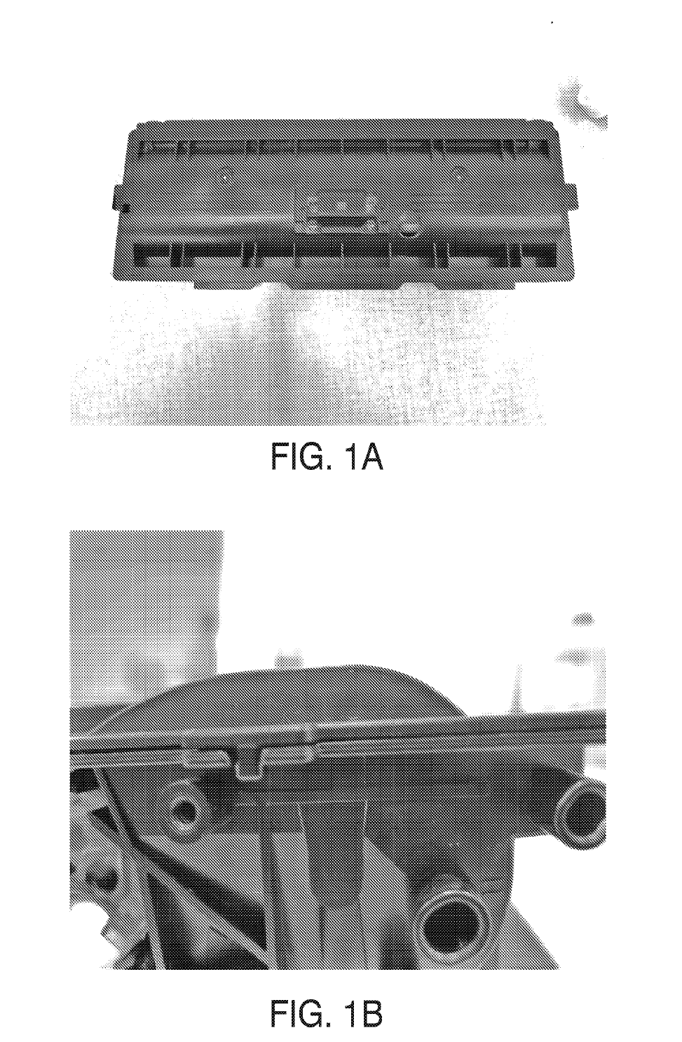

### DETAILED DESCRIPTION OF THE INVENTION

### Embodiment (1)

The present invention provides a method to replace or reinstall seals on a toner hopper and/or the toner opening port of a toner hopper.

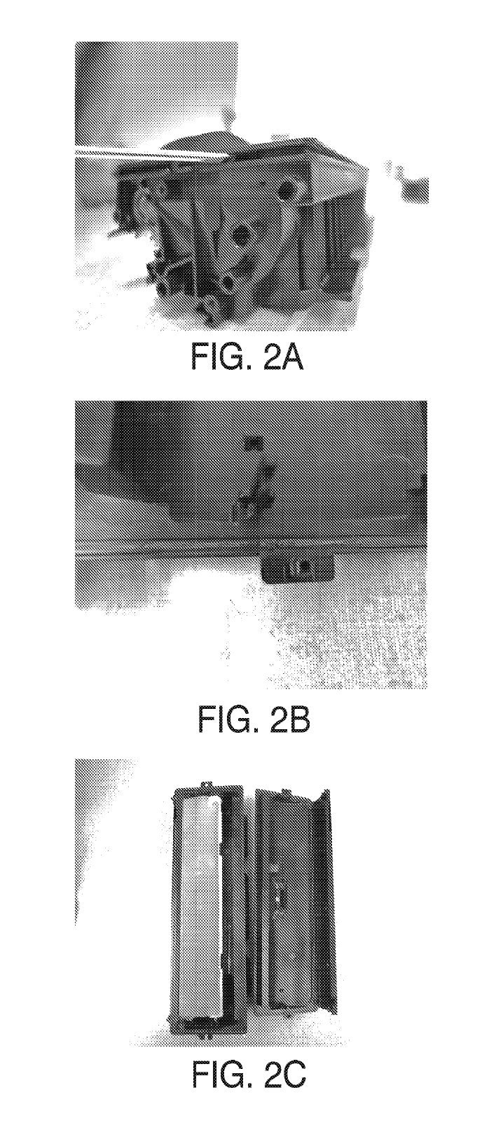

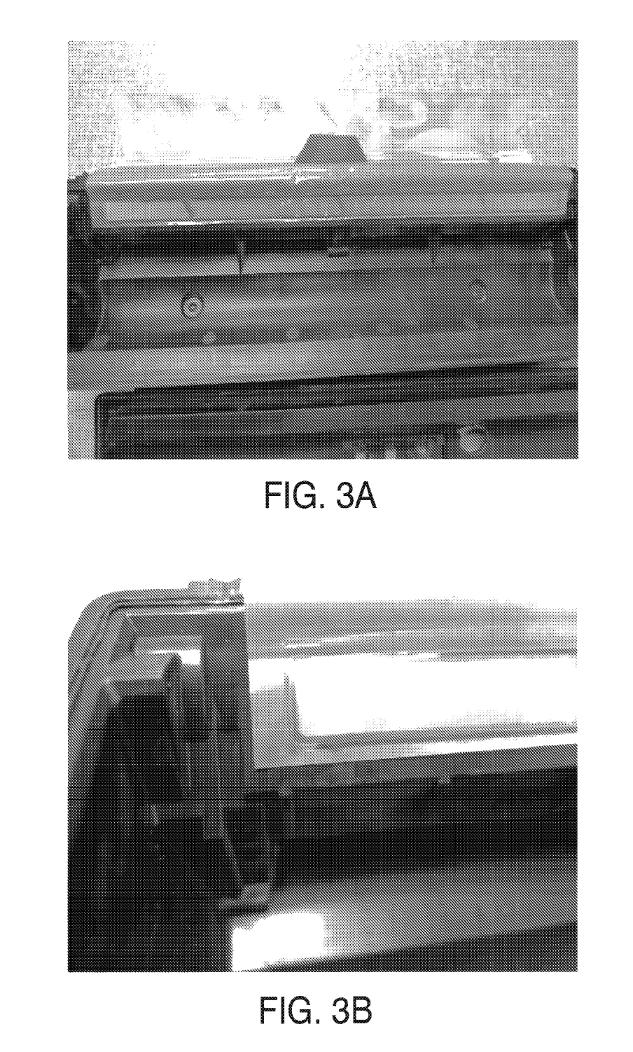

A toner cartridge may be opened through any method known in the art. A toner cartridge may be opened using a tool. In one embodiment, the toner cartridge is opened using a screwdriver as shown in FIG. 2A.

Once the toner cartridge is opened, the seal that was installed by the original equipment manufacturer can be collected. The seal may be collected from wherever it is located in the toner cartridge. The seal may be collected from the toner hopper. The seal may be collected from any location within the toner hopper, such as the bottom vessel of the toner hopper.

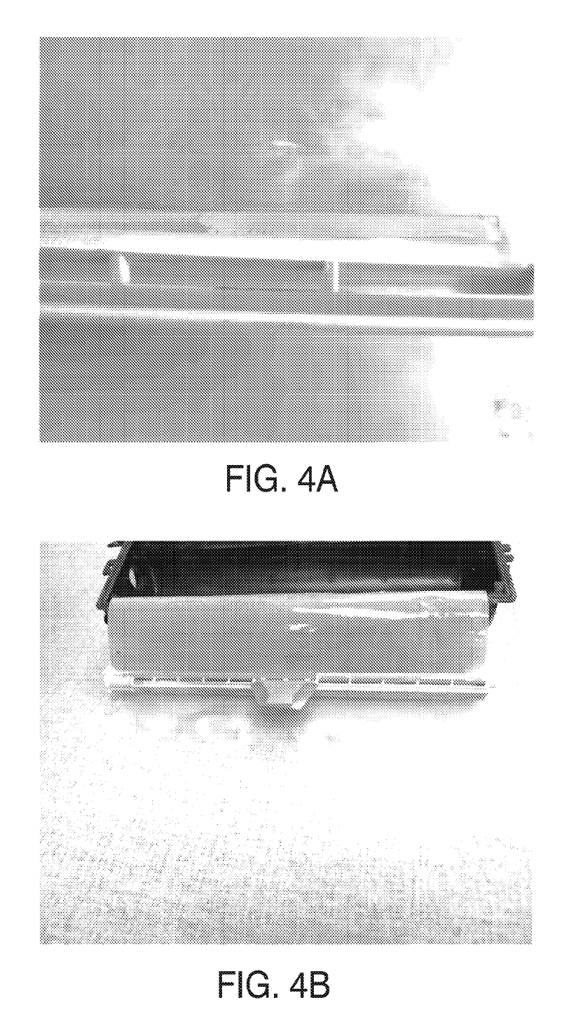

In an embodiment of the invention, after the seal is collected, it may be attached or reattached to the agitator in any manner known to those of skill in the art. The seal may be attached to the agitator as shown in FIG. 4B. The seal may be wrapped around the agitator. In an embodiment of the invention, the seal is attached or reattached to the agitator. The seal may be made of any material known to those of skill in the art. The seal may have a tab. The seal may have a tab as shown in FIG. 4A. The tab may be the part of the seal that is attached to the agitator. The tab may be the part of the seal that makes physical contact with the agitator.

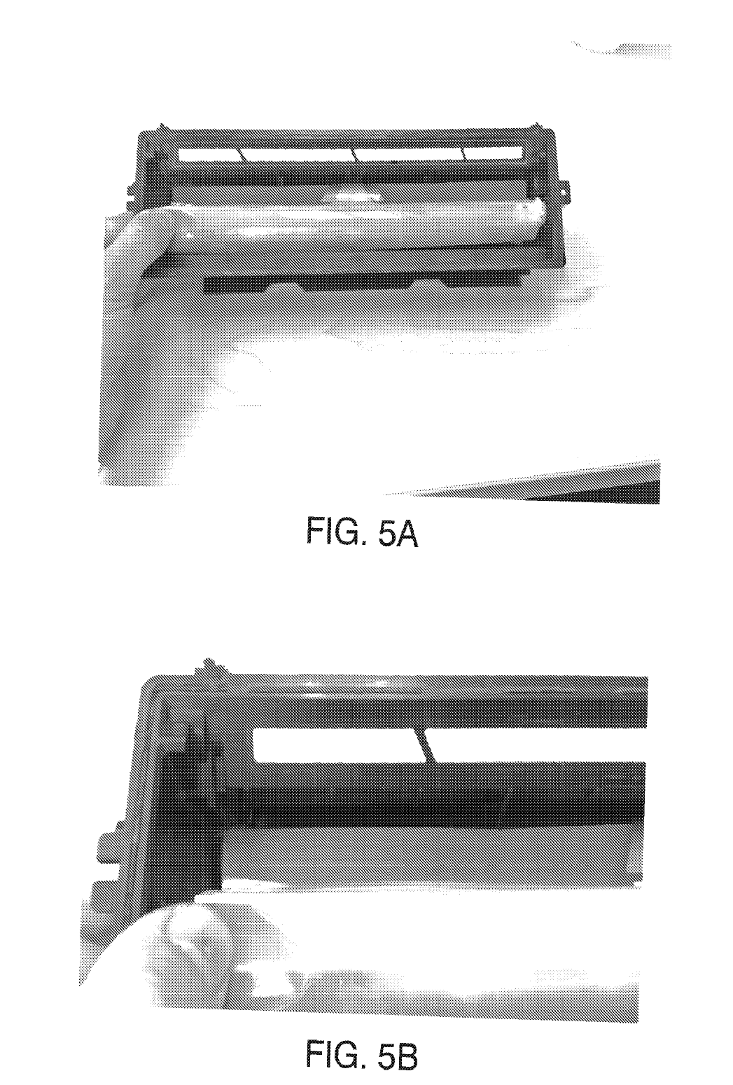

In an embodiment of the invention, once the seal is attached to the agitator, it is disposed over the toner opening port of the toner hopper. A gasket may be affixed to the perimeter of the toner opening port of the toner hopper. The gasket may be made of any material known to those of skill in the art. The seal may be affixed to the gasket at any time in accordance with the invention. The gasket may have at least one adhesive layer. The gasket may have two adhesive layers. The gasket may have multiple adhesive layers. An adhesive layer of the gasket may be used to adhere the gasket to the perimeter of the toner opening port of the toner hopper. The gasket may be adhered to the perimeter of the toner opening port of the toner hopper in any manner or in any location known to those of skill in the art. A gasket may be adhered to the perimeter of the toner opening port of the toner hopper as shown in FIG. 5A.

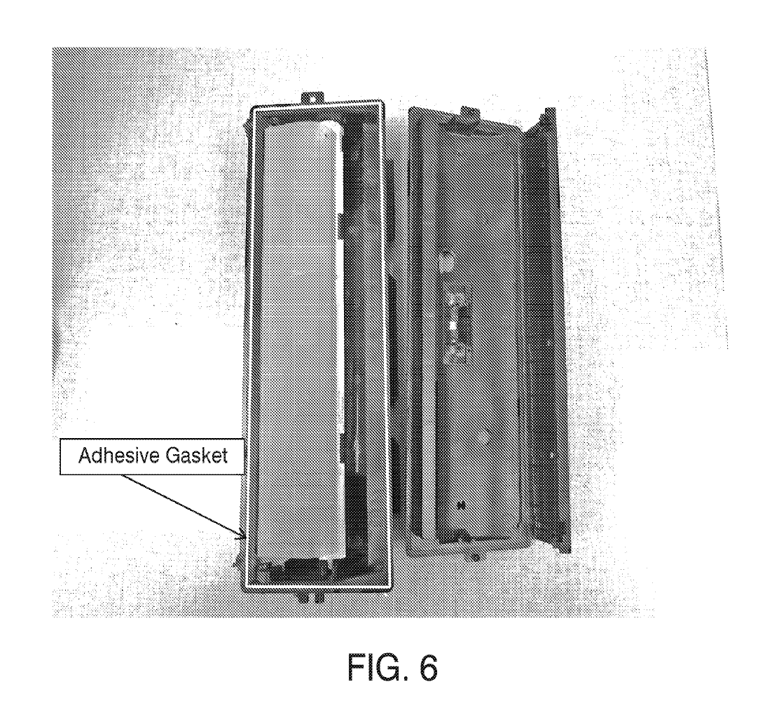

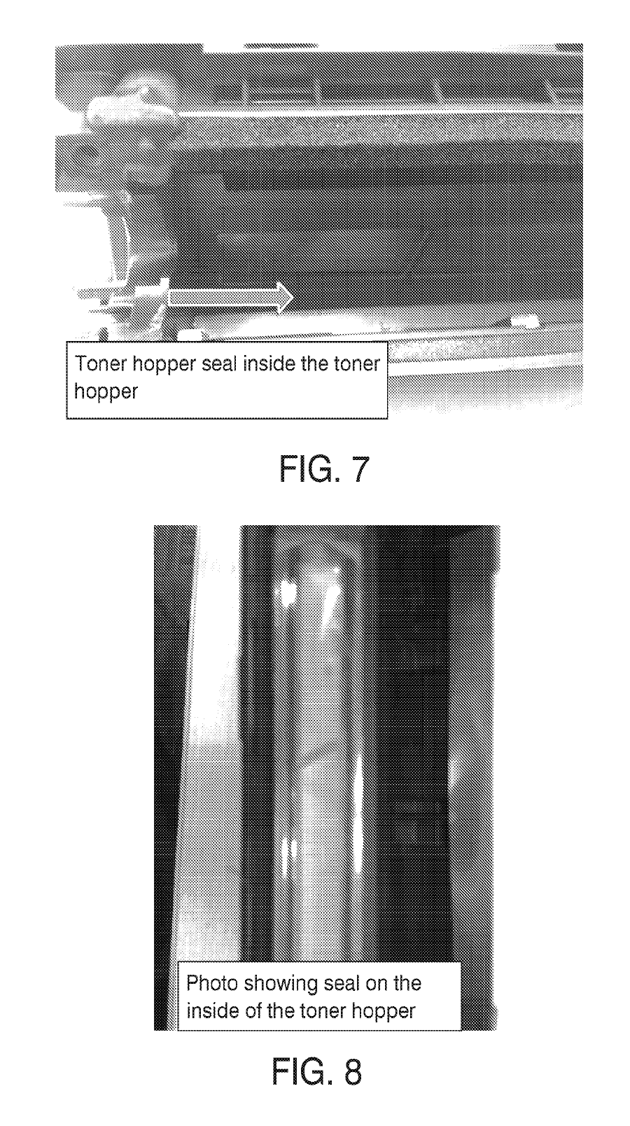

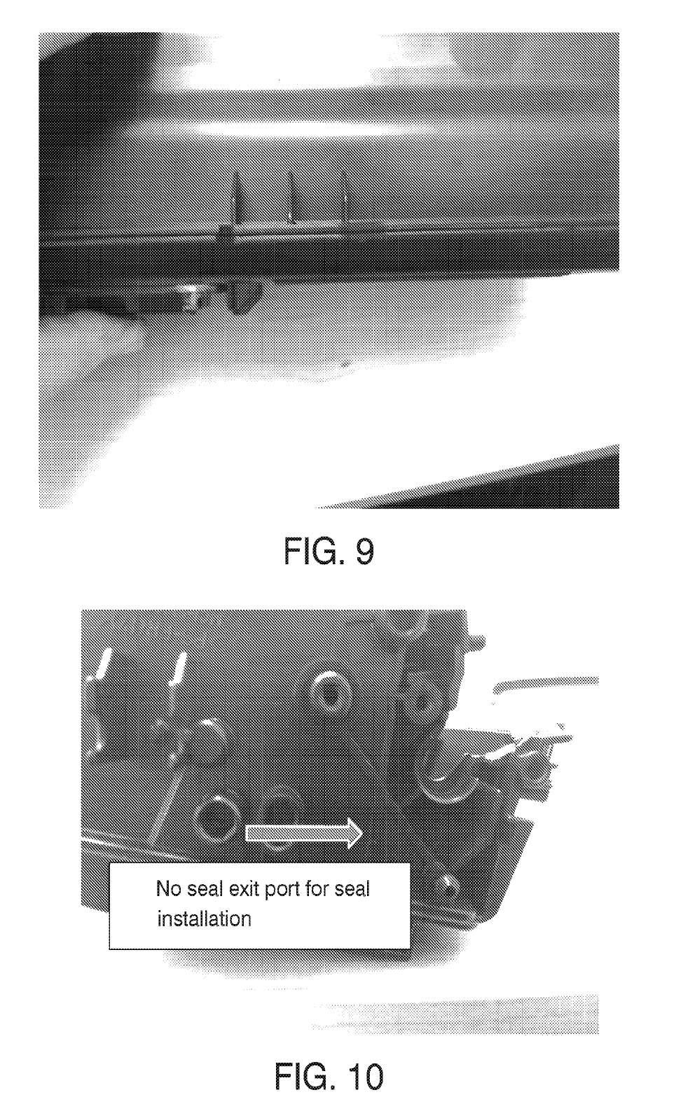

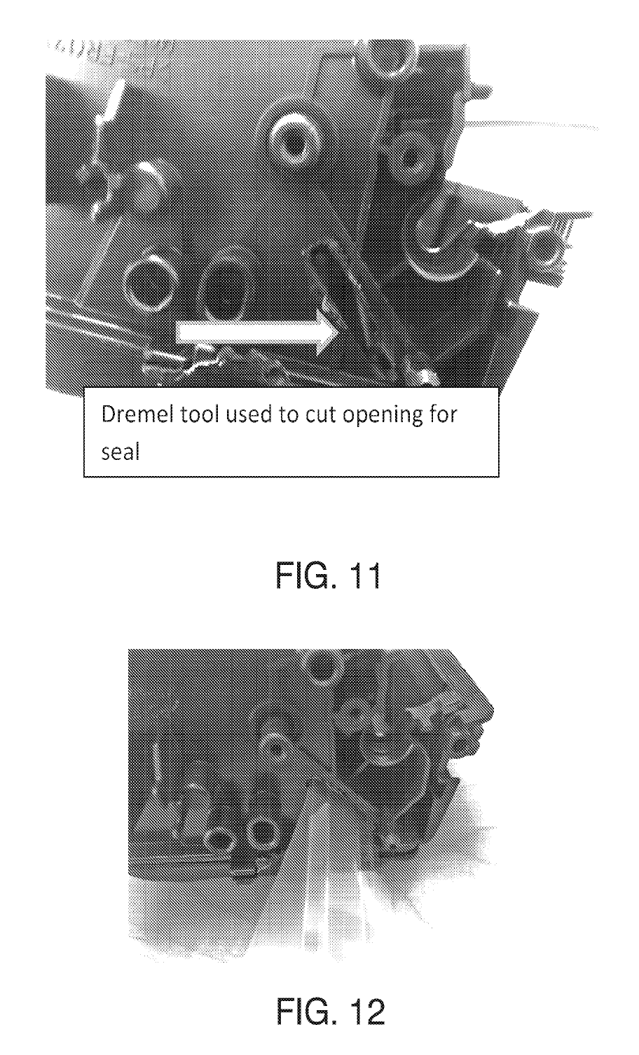

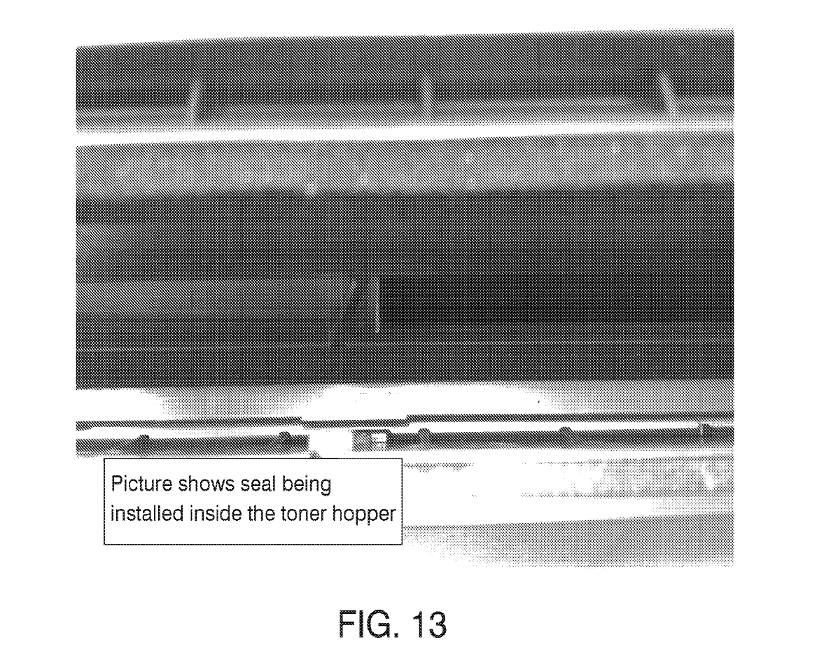

In an embodiment of the invention, a gasket may be affixed to the perimeter of the top of the bottom vessel of the toner hopper. The gasket may be made of any material known to those of skill in the art. The seal may be affixed to the gasket at any time in accordance with the invention. The gasket may have at least one adhesive layer. The gasket may have two adhesive layers. The gasket may have multiple adhesive layers. The gasket may be adhered to the perimeter of the bottom vessel of the toner hopper n any manner or in any location known to those of skill in the art. A gasket may be adhered to the perimeter of the top side of the bottom vessel of the toner hopper as shown in FIG. 6. A gasket may be used to adhere the top closure of the toner hopper to the bottom vessel of the toner hopper. The gasket may be adhered to the top closure of the toner hopper. While the embodiments disclosed here discuss using a gasket, any adhesive, bonding agent, or method could also be used to achieve the invention. For example, the top vessel of the toner hopper and bottom vessel of the toner hopper may be bonded together with a weld, such as a heat weld or sonic weld.

Methods and devices for sealing toner opening ports of printer cartridges are known in the art and are disclosed in U.S. Pat. Nos. 7,835,664, 7,986,900, and 8,369,741, all of which are incorporated herein by reference.

The above description sets forth, rather broadly, a summary of the disclosed embodiments. There may be, of course, other features of the disclosed embodiments that will be appreciated by a person of skill in the art based on the description and may form the subject matter of claims. The features, functions, and advantages that have been discussed can be achieved independently in various embodiments of the disclosure or may be combined in yet other embodiments, further details of which can be seen with reference he following description.

The order in which the steps are presented is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

The disclosed embodiments provide various devices and methods for remanufacturing printer cartridge components of laser printers, such as laser cartridges, toner cartridges, or printer cartridge components. The disclosed embodiments of the devices and methods may be used with printer cartridge components that can be used in laser printer models, such as the Hewlett Packard Corporation HP-M553 family of laser printers, or other HP laser printer models, and may also be used with other suitable printer cartridges.

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and not for purposes of limitation. The invention is not limited in its application to the details of the construction and to the arrangement of the components set forth in the above description or as illustrated in the drawings.

### Embodiment (2)

The present invention satisfies the need for methods and devices for accessing the toner opening port of the toner hopper to install a replacement seal and remanufacture a printer cartridge. One embodiment of the invention comprises a method for sealing or resealing the toner hopper of a printer cartridge. The printer cartridge contains various components, including a toner hopper. The toner hopper has a partially open end that allows toner to be used by the printer cartridge to form an image. The toner hopper is otherwise a closed box. A hole is cut or melted in a wall of the printer cartridge to access an internal area of the printer cartridge. The hole may be formed by any method known in the art. The hole will lead to the toner opening port of the toner hopper. A seal is inserted through the hole into the internal area of the printer cartridge. The seal is affixed to the toner opening port. The toner opening port is closed with the seal to prevent toner from leaking from the toner hopper during shipment or before the cartridge is used.

In one embodiment, the internal area of the toner cartridge is accessed by cutting a hole in a wall of the printer cartridge. In another embodiment, the seal is affixed to the toner opening port of the toner hopper. The seal may be affixed with an adhesive, heat, or any other method known in the art. In one embodiment of the invention, the original seal is removed from the toner hopper. Toner can be replenished in the toner hopper.

Cutting the hole in the wall of the printer cartridge will usually create debris. In an embodiment of the invention, the debris is removed. The debris may be removed by blowing, sweeping, vacuuming, or any other method known in the art. In one embodiment, the method comprises aligning a guide next o the printer cartridge. The guide may be aligned to determine where the hole should be cut, or in some embodiments, the location of the optimal position for the hole.

In one embodiment, the hole is cut in an optimal position to insert the seal to cover the toner opening port. In one embodiment, the optimal position will allow the least resistance and provide the shortest path to insert the seal and affix it to the toner opening port. In one embodiment, the optimal position is a wall of the printer cartridge adjacent to the toner opening port of the toner hopper. In some embodiments, the optimal position is not on a seam of the printer cartridge or in a position that would create an additional port in the toner hopper. The hole may be cut by sawing, drilling, or any other method known in the art.

In one embodiment of the invention, the hole is filled with a plug. The plug can be made of any material known in the art. The plug may be attached to the seal. The seal may be configured to close the hole.

One embodiment of the invention is a method of creating, a guide to determine the optimal placement of a hole in a wall of a second printer cartridge. In one embodiment, the method comprises aligning the guide against a printer cartridge with a hole and marking the guide to indicate the placement of the hole on the printer cartridge. In one embodiment, the guide is used to determine where to cut a hole in a second printer cartridge. In one embodiment, the guide is used to cut a hole in a wall of a second printer cartridge.

One embodiment of the invention is a method of creating a guide to determine the optimal placement of a hole in a wall of a printer cartridge. In one embodiment, the method comprises measuring the dimensions of the printer cartridge, determining the optimal placement of a hole in the wall of the printer cartridge, and preparing a guide incorporating the dimensions of the printer cartridge and the optimal placement of a hole in the wall of the printer cartridge. In one embodiment, the method comprises aligning the guide with a printer cartridge. In another embodiment, the method comprises using the guide to cut a hole in the wall of a printer cartridge. The guide may be made from paper, wood, plastic, or any other material known in the art.

One embodiment of the invention is an apparatus that can access the inside of a toner cartridge. The apparatus can comprise a cutting tool. The cutting tool can comprise a rotary tool, Dremel tool, or any other apparatus known in the art. The apparatus may comprise a tool that a seal into the internal area of the toner cartridge. The apparatus may comprise a tool that affixes a seal on the toner hopper. The apparatus may comprise a tool that removes debris.

Methods and devices for sealing toner opening ports of printer cartridges are known in the art and are disclosed in U.S. Pat. Nos. 7,835,664, 7,986,900, and 8,369,741, all of which are incorporated herein by reference.

The above description sets forth, rather broadly, a summary of the disclosed embodiments. There may be, of course, other features of the disclosed embodiments that will be appreciated by a person of skill in the art based on the description and may form the subject matter of claims. The features, functions, and advantages that have been discussed can be achieved independently in various embodiments of the disclosure or may be combined in yet other embodiments, further details of which can be seen with reference to the following description.

The order in which the steps are presented is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

The disclosed embodiments provide various devices and methods for remanufacturing printer cartridge components of laser printers, such as laser cartridges, toner cartridges, or printer cartridge components. The disclosed embodiments of the devices and methods may be used with printer cartridge components that can be used in laser printer models, such as the Hewlett Packard Corporation HP-M252 and HP-M552 families of laser printers, or other HP laser printer models, and may also be used with other suitable printer cartridges.

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and not for purposes of limitation. The invention is not limited in its application to the details of the construction and to the arrangement of the components set forth in the above description or as illustrated in the drawings.

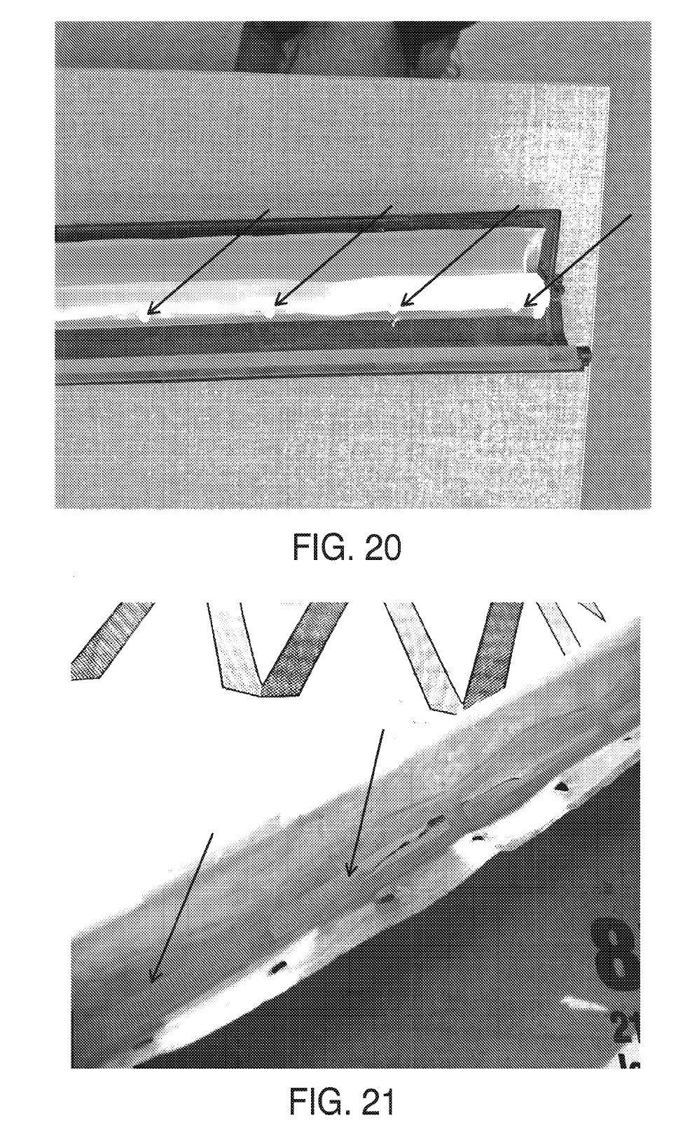

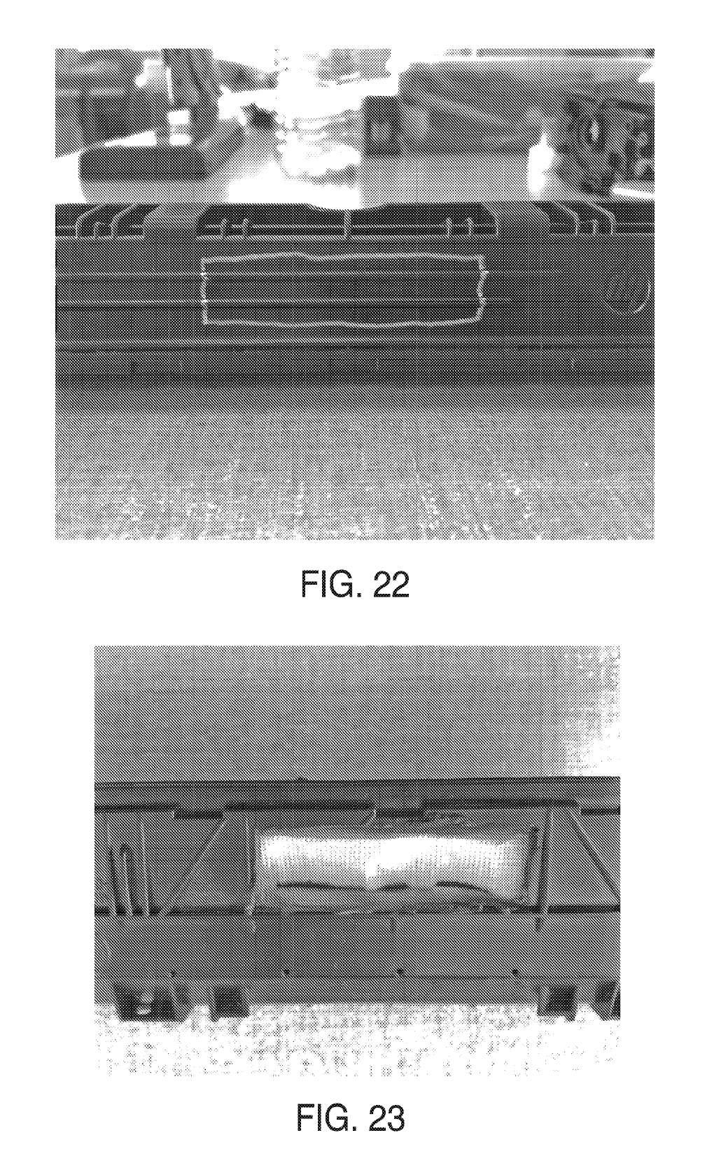

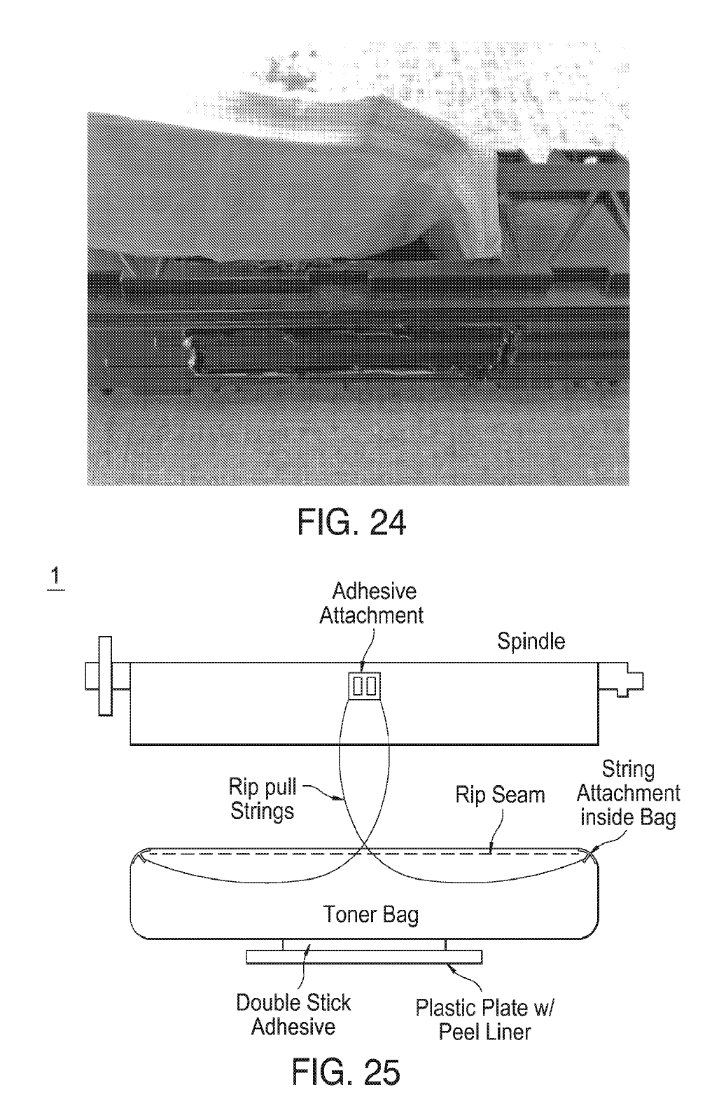

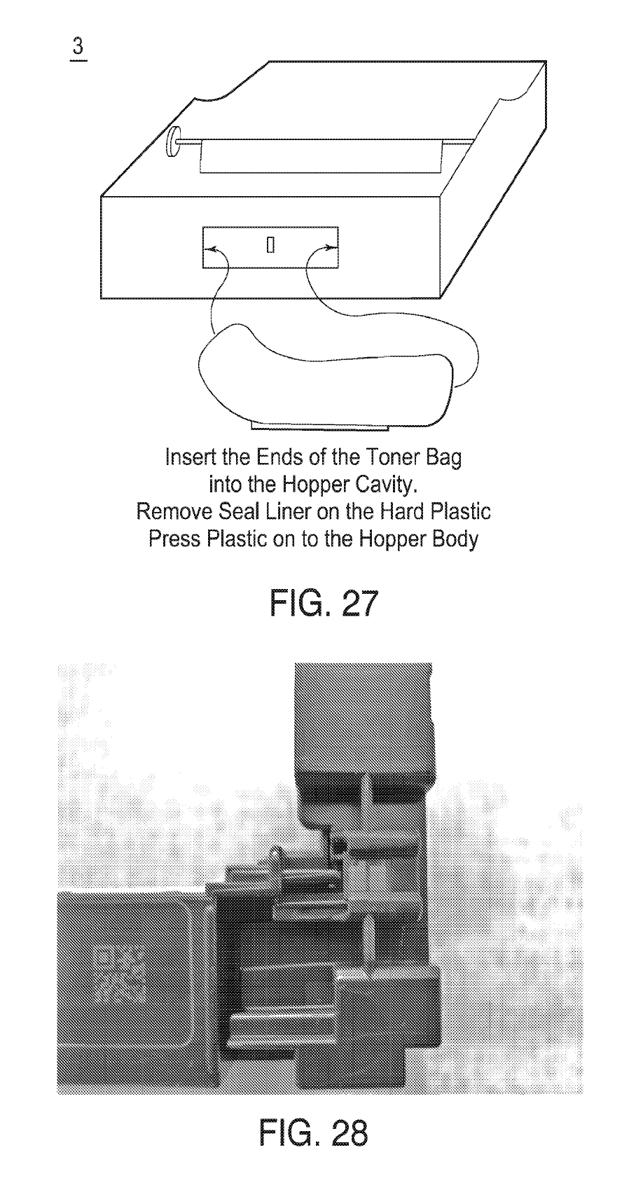

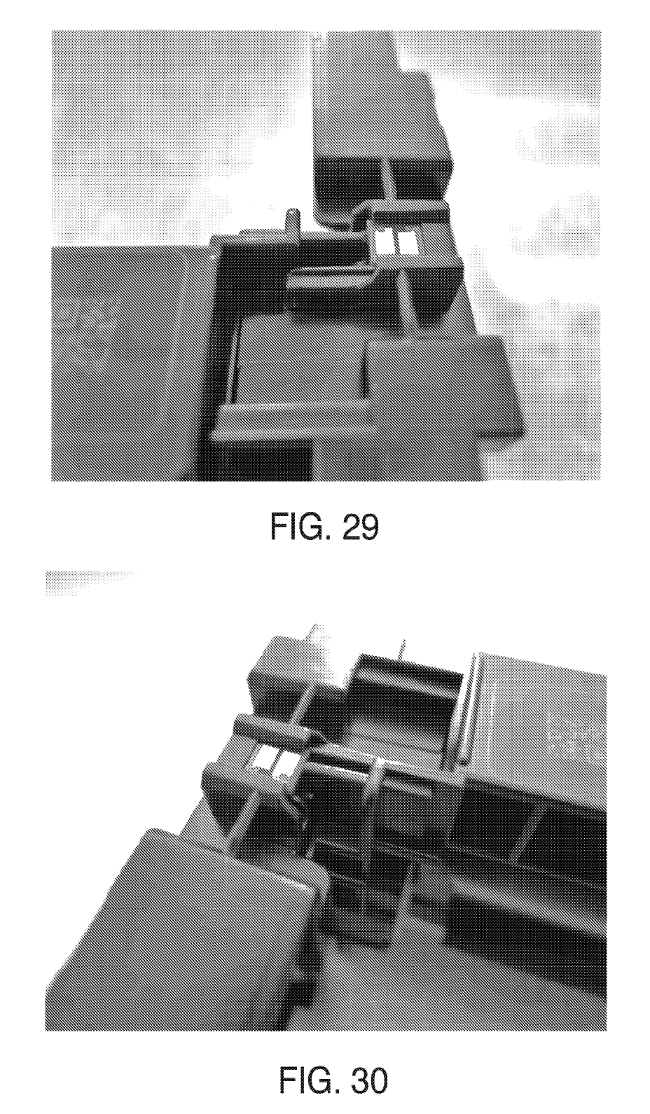

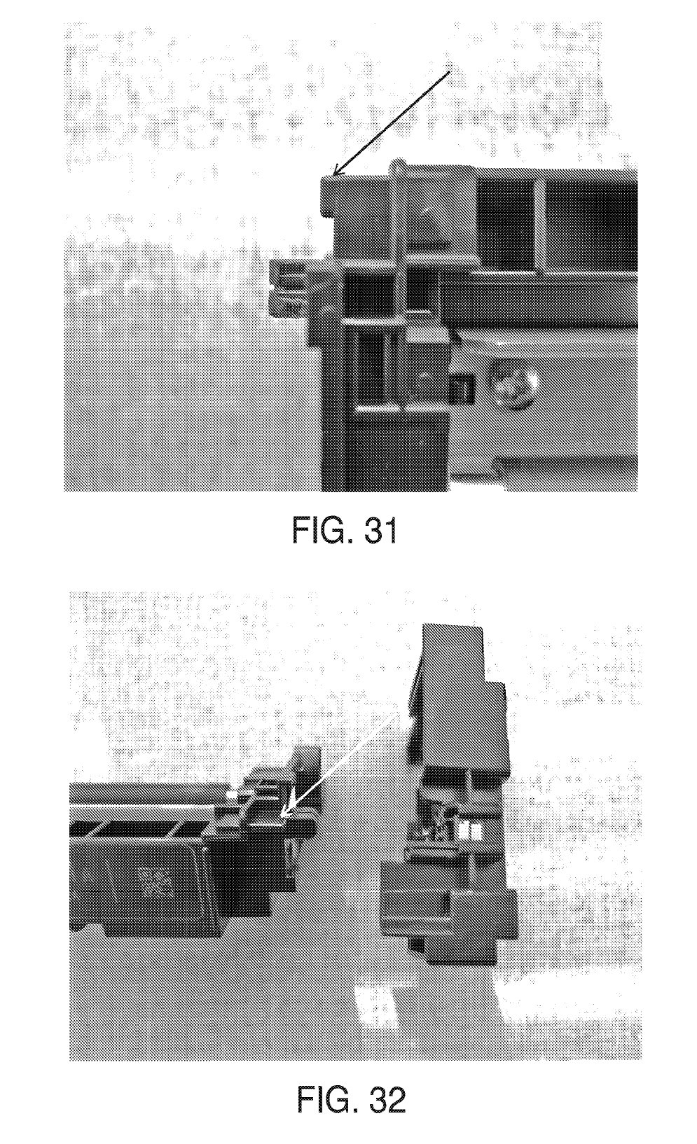

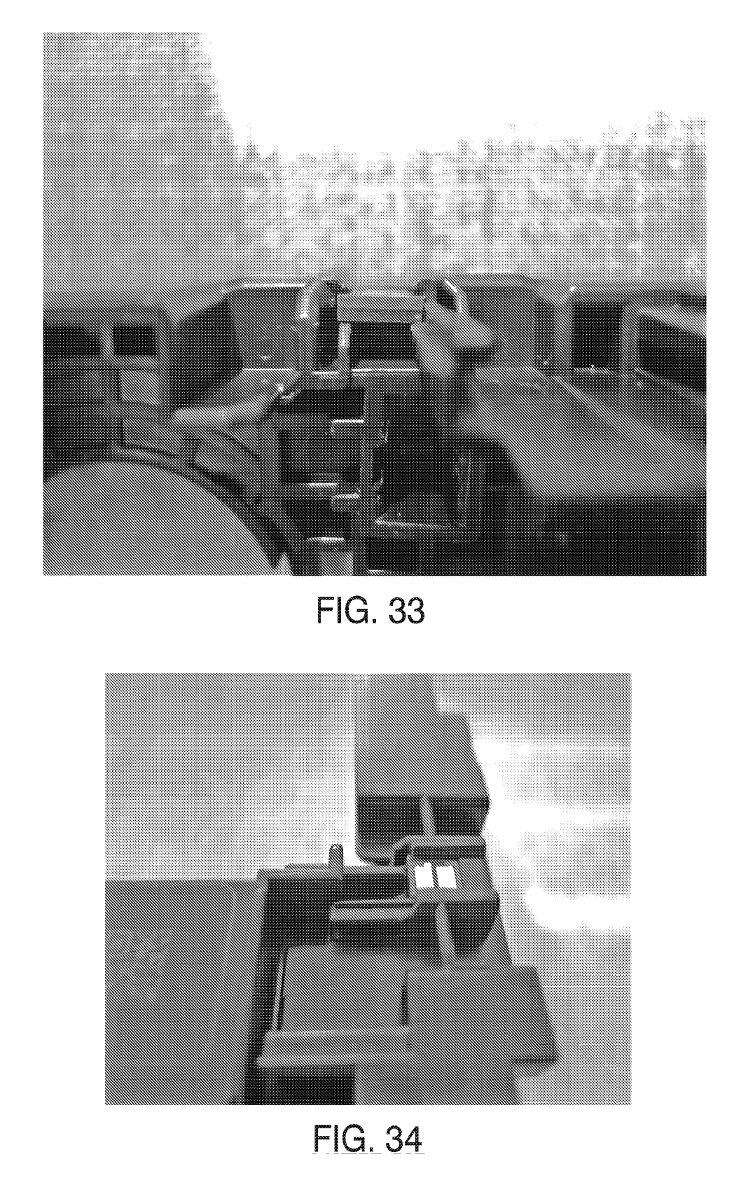

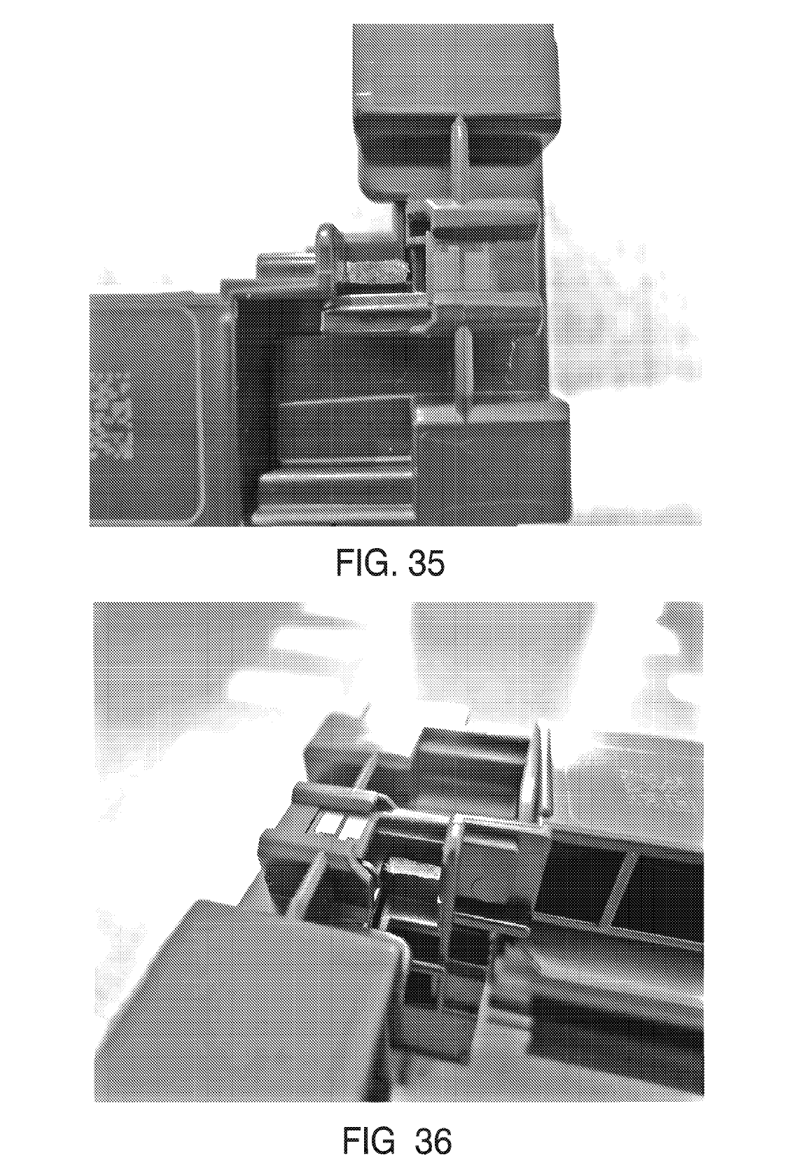

With reference to the drawings, FIG. 20 shows a top perspective view of the OEM designed bag of toner attached by its seal strip to the agitator of the toner hopper; FIG. 21 shows a top perspective view of the OEM designed bag of toner after it has been installed in the printer, the agitator has rotated, pulled off the seal, and opened the bag, allowing toner to flow from the bag of toner into the toner hopper, and removed from the toner hopper; FIG. 22 shows a side view of a toner cartridge identifying a potential area to access the inside of the toner hopper; FIG. 23 shows a side view of a toner cartridge with a hole in it to access the inside of the toner hopper; FIG. 24 shows a side view of a toner cartridge with a hole in it through which a bag of toner is being removed; FIG. 25 shows a replacement bag of toner to be installed in the toner hopper; and FIG. 27 shows the insertion of a replacement bag of toner into the toner hopper.

### Embodiment (3)

### EXAMPLE 1

### Sealing the Toner Hopper

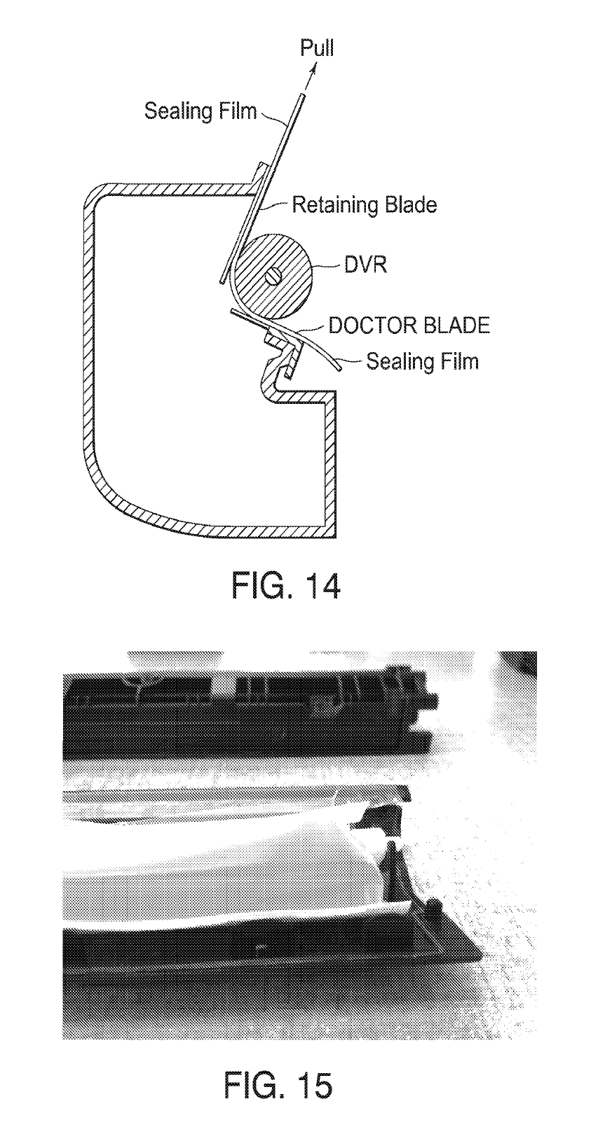

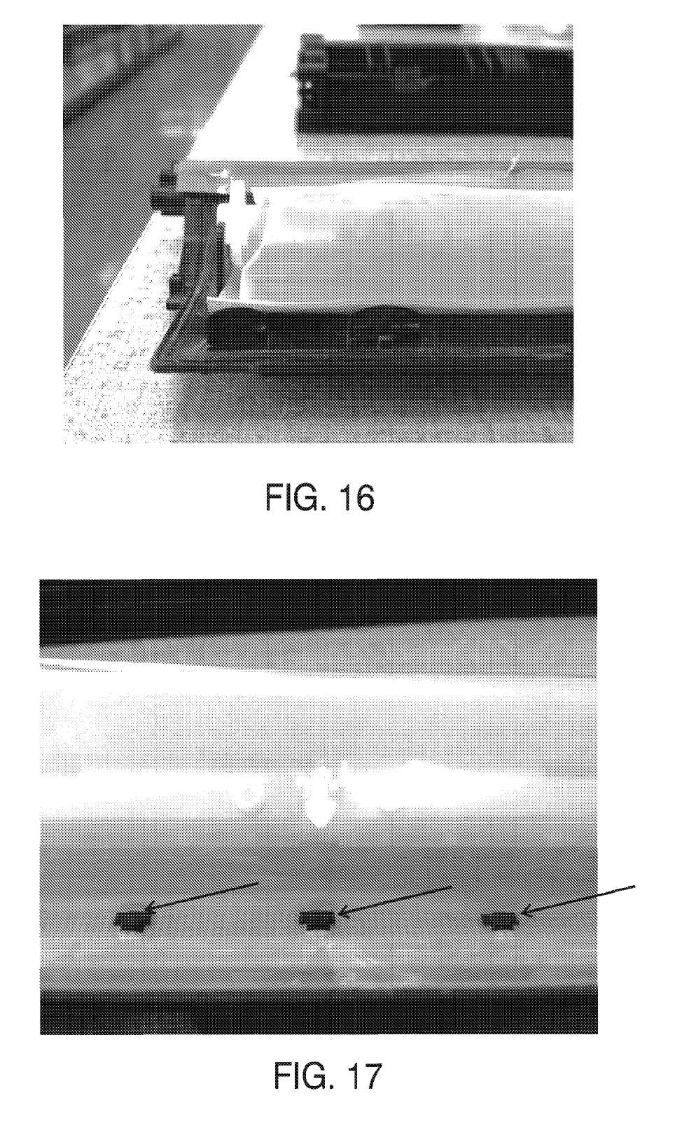

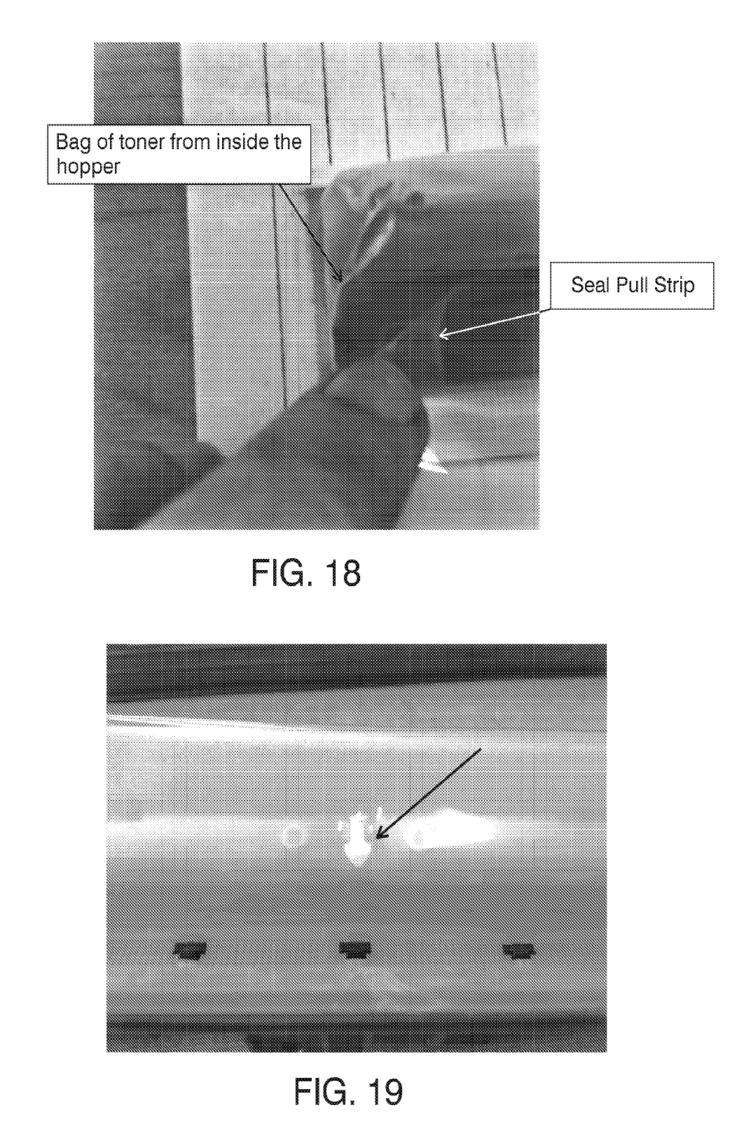

The disclosed inventions satisfy the need for methods and devices for installing or replacing seals on toner hoppers. The invention may be embodied in a seal disposed over the toner opening of the toner hopper, and on op of the doctor blade and retaining blade of the toner hopper. As depicted in FIG. 14, a seal completely covers the toner opening of the toner hopper. The entire cartridge may be reassembled or remanufactured with the seal disposed within it. Such a reassembly or remanufacture may include replacing or installing parts or accessories, such as, though not limited to, developer roller, supply roller end foam, bushings, and toner unit end cap. In an embodiment the seal has at least one pull tab. A pull tab may be located on the top side of the toner unit. To remove the seal, the seal is pulled out of the toner unit. In an embodiment, one or more pull tabs are used to pull the seal out of the toner unit. The seal may be made of anti-static material.

### EXAMPLE 2

### Toner Bag Replacement

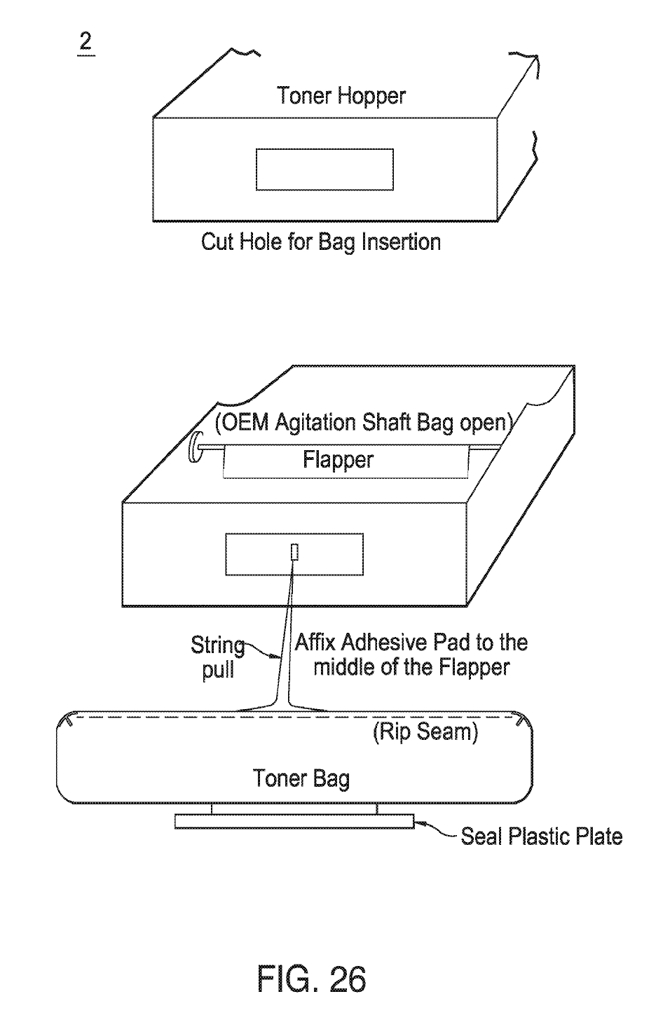

The disclosed inventions satisfy the need for methods and devices for removing and replacing a bag of toner in a toner hopper. As depicted in FIGS. 22-27, the invention may be embodied by accessing an internal area of the printer hopper and removing a bag of toner. In an embodiment, a replacement bag of toner is inserted. Toner can be replenished in the toner hopper.

In one embodiment, the internal area of the toner hopper is accessed by cutting a hole in a wall of the toner cartridge. The bag of toner may be removed through the hole. The replacement bag of toner may be inserted through the hole. The replacement bag of toner may be filled at any time. The replacement bag of toner may be filled before it is inserted in the toner hopper or after it is inserted in the toner hopper.

The replacement bag of toner may have an adhesive to adhere the bag to the inside of the toner hopper. The adhesive may be protected by a liner, which may be removed to expose the adhesive. The replacement bag of toner may also have a string to attach the bag to an agitator in the toner hopper. The string can be attached to the agitator so that the agitator opens the replacement bag of toner once the remanufactured or reassembled printer cartridge is activated. The replacement bag of toner may be perforated.

Cutting the hole in the wall of the printer cartridge will usually create debris. In an embodiment of the invention, the debris is removed. The debris may be removed by blowing, sweeping, vacuuming, or any other method known in the art. In one embodiment, the method comprises aligning a guide next to the printer cartridge. The guide may be aligned to determine where the hole should be cut, or in some embodiments, the location of the optimal position for the hole.

In one embodiment, the hole is cut in an optimal position to insert the replacement bag of toner. In one embodiment, the optimal position will allow the least resistance and provide the shortest path to insert the replacement bag of toner one embodiment, the optimal position is a wall of the printer cartridge adjacent to the agitator of the toner hopper. In some embodiments, the optimal position is not on a seam of the printer cartridge or in a position that would create an additional port in the toner hopper. The hole may be cut by sawing, drilling, or any other method known in the art.

In one embodiment f the invention, the hole is filled with a plug. The plug can be made of any material known in the art. The plug can be the material removed to access the internal area of the printer hopper. The material can be melted or welded and can be sealed by any method known in the art.

### Embodiment (4)

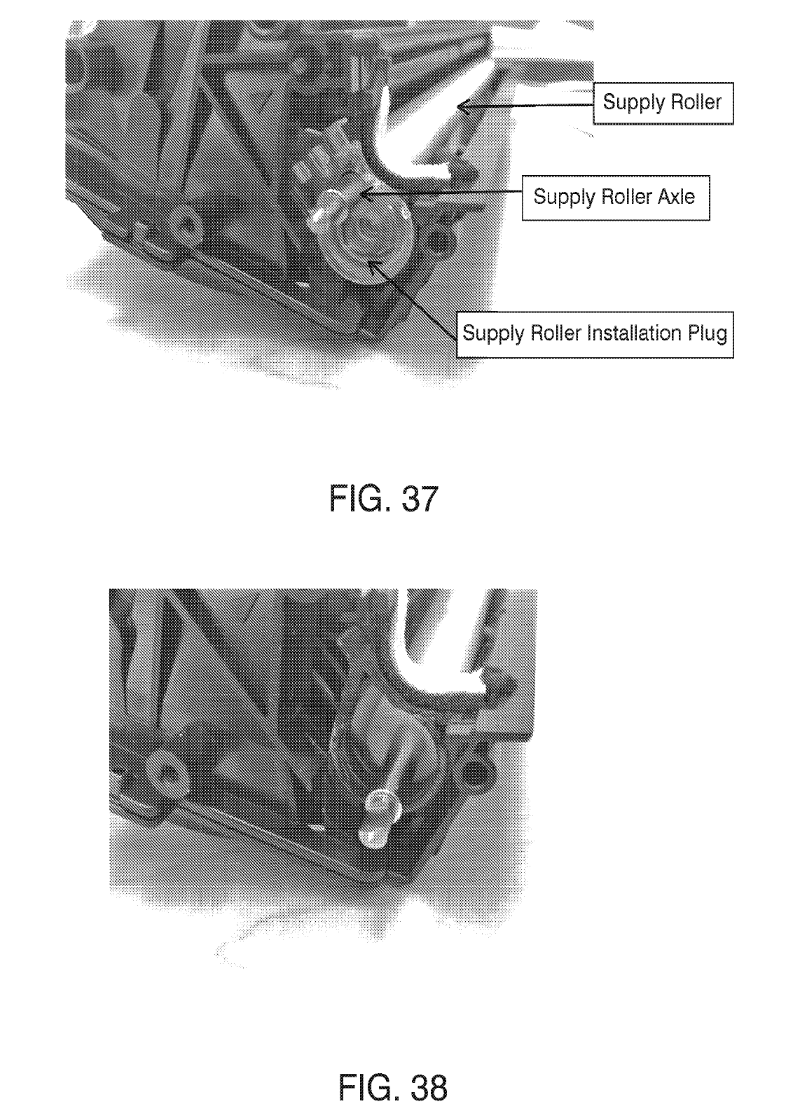

The first aspect of this embodiment relates to devices and methods for resealing a toner cartridge through a supply roller plug, such as the HP M552/M553 cartridges. This aspect of the invention is shown in FIGS. 37-43.

In the case of the HP M552/M553 cartridges, the manufacturer seals the cartridge on the inside of the toner hopper. This makes it difficult to reseal the toner hopper.

This embodiment of the invention is based on the concept of add a toner seal to the outside of the toner hopper similar to the old style toner cartridges. The supply roller is installed through a hole in the side of the toner hopper. The hole is then covered using a plastic “plug” that is sonically welded to the toner hopper to prevent leaking. The shaft of the supply roller fits through a hole in the plastic “plug”. This aspect of the invention is shown in FIG. 37, which shows the shaft of the supply roller fits through a hole in the plastic plug.

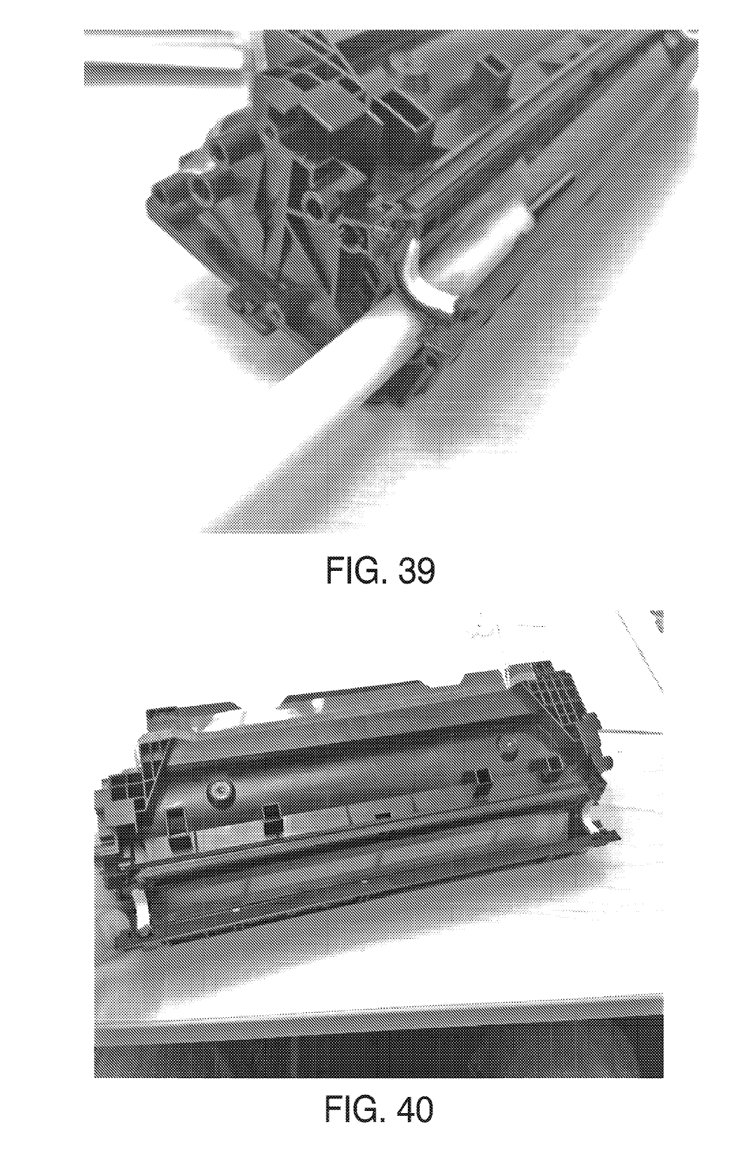

The supply roller can be removed from the toner hopper using pressure or pried from the side of the toner hopper. FIG. 38 shows the plug removed from the toner hopper. The removal of the supply roller “plug” allows the supply roller to be removed from the toner hopper. FIG. 39 shows removal of the supply roller from the toner hopper.

With the supply roller removed from the toner hopper a seal can then be placed onto the seal area on the “outside” of the toner hopper. FIG. 40 shows placing a seal onto the seal area on the outside of the toner hopper.

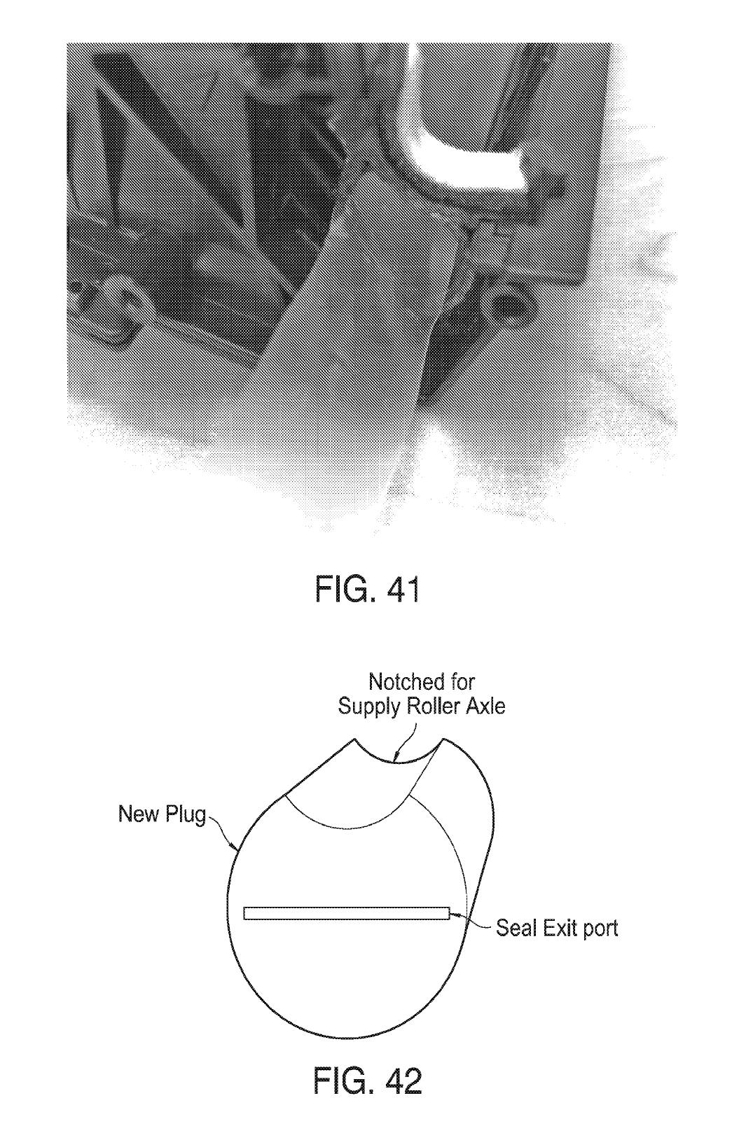

The pull strip portion of the seal can then be installed through the hole used to install the supply roller. FIG. 41 shows installing the pull strip portion of the seal through the hole used to install the supply roller.

A new supply roller plug can then be installed into the end of the toner hopper with a cutout that allows the end user to remove the seal from the toner hopper. The seal pull strip can be fed through the seal exit port on the new supply roller plug,

The plug can be molded from plastic or made of rubber. The new plug can be attached to the toner hopper using adhesive or glue. FIG. 42 shows a supply roller plug which contains a notched portion to receive the supply roller axle and a seal exit port.

The second aspect of this embodiment is relates to methods and devices for reattaching a cartridge end cap to a waste hopper.

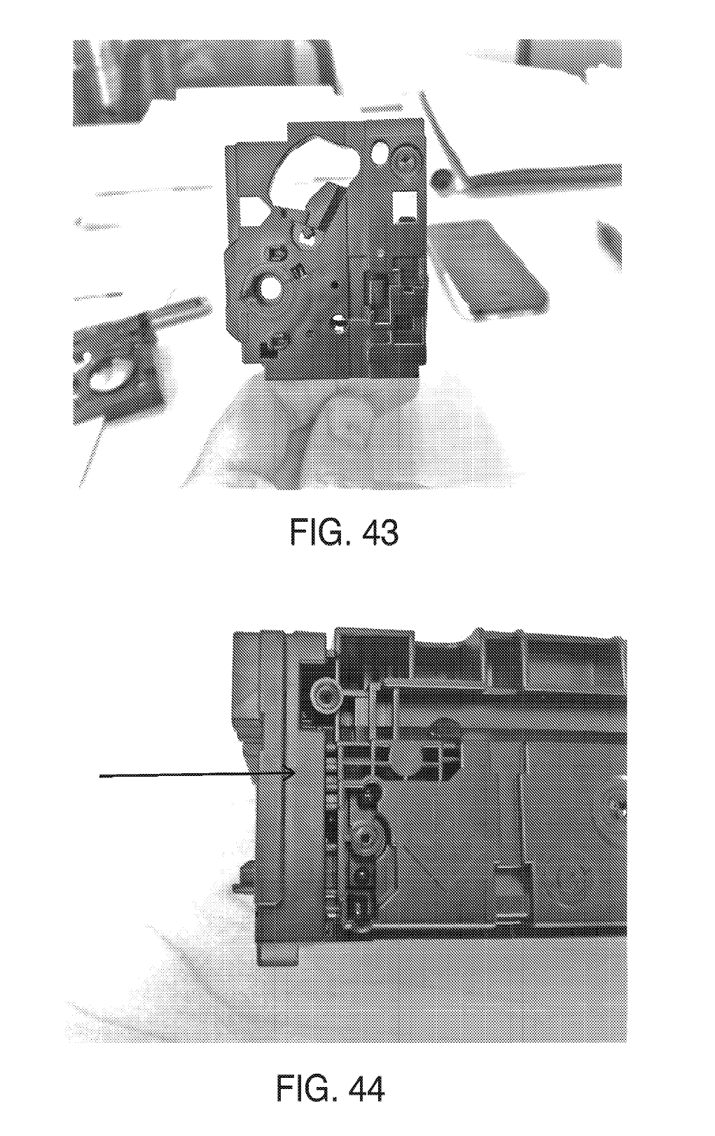

The toner cartridge end cap is sonically welded to the toner hopper. To remove the end cap one must break the sonic weld. FIG. 43 shows a cartridge end cap.

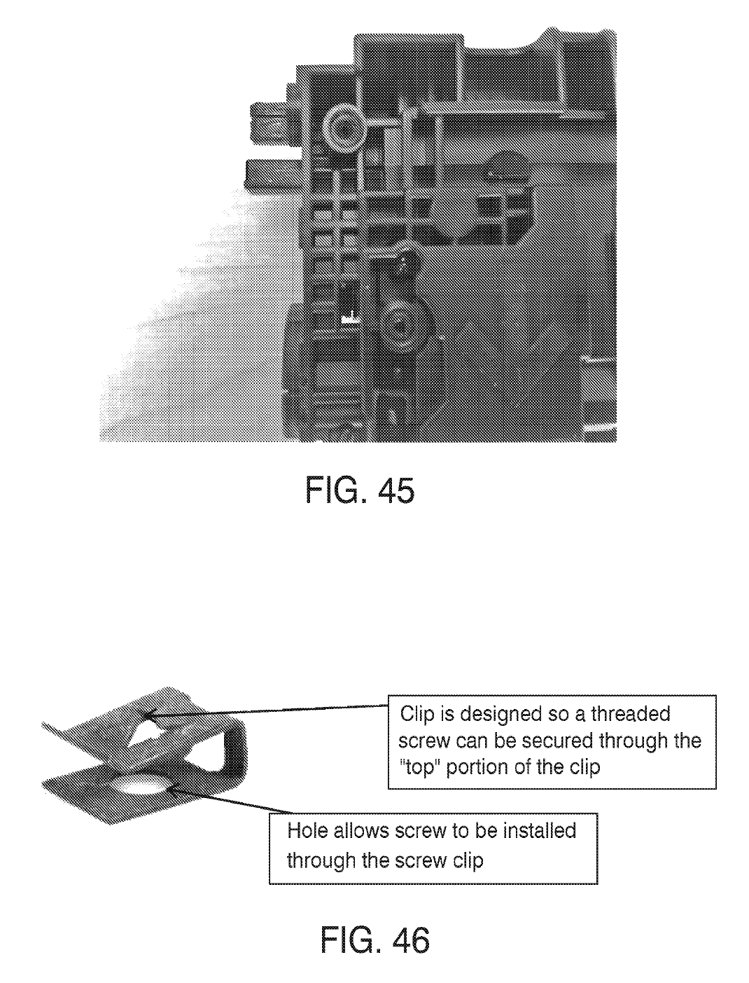

When the cartridge is reassembled there is not a way to reattach the end cap to the waste hopper since the sonic weld has been broken. The present invention provides for drilling a hole through the end cap and waste hopper. The preferred spot can be drilled using a fixture to ensure proper placement. The sonic weld is then broken, freeing the end cap from the waste hopper. FIG. 44 shows a preferred spot for drilling a hole through the end cap and the waste hopper. FIG. 45 shows breaking the sonic weld freeing the end cap from the waste hopper.

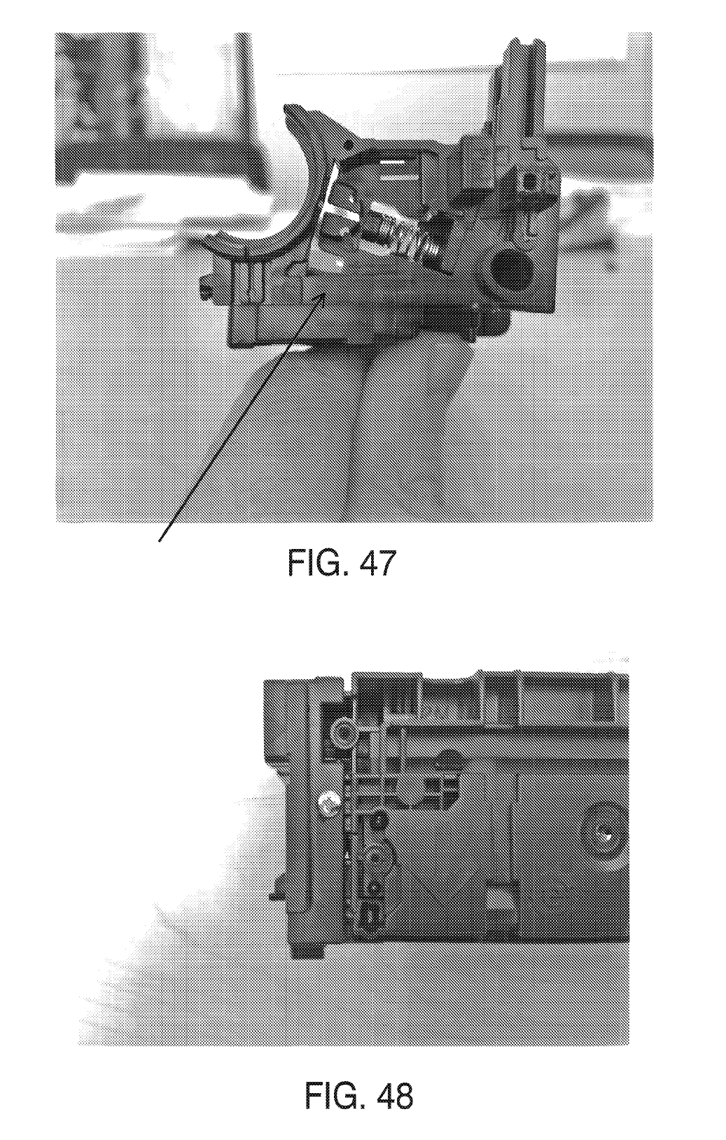

To reattach the cartridge end cap, one can attach a screw clip to the waste hopper. FIG. 46 shows a screw clip designed so that a threaded screw can be secured through the top portion of the clip and also has a hole which allows a screw to be installed through the screw clip. FIG. 47 shows a waste hopper.

A screw can then be installed through the cartridge end cap and waste hopper which will lock the end cap in place. FIG. 48 shows the cartridge end cap reattached to the waste hopper by the screw clip and a screw.

High torque can cause the plastic to strip. One benefit of using the screw clip the plastic is not stripped. The screw clip will hold the end cap in place.

The third aspect of this embodiment of the present invention relates to a soft shell bottle designed to be incorporated into a toner cartridge. The bottle may be composed of a soft polymeric material, such as polypropylene (PP), polyethylene (PE), polyethylene terephthalate (PET) or nay combination thereof. The soft shell bottle is preferably has a cylindrical shape. In one embodiment, one or both of the ends of the bottle may be fitted with end caps. The end caps may be made of the same material as the bottle itself. The body of the bottle may contain a series of holes. In a preferred embodiment, the holes are covered with a seal. The seal can then be removed from the body of the bottle when the toner cartridge is used. In another preferred embodiment, the body of the body contains a series of protrusions which come into contact with the flaps of an agitator during use. In a preferred embodiment, the bottle contains toner.

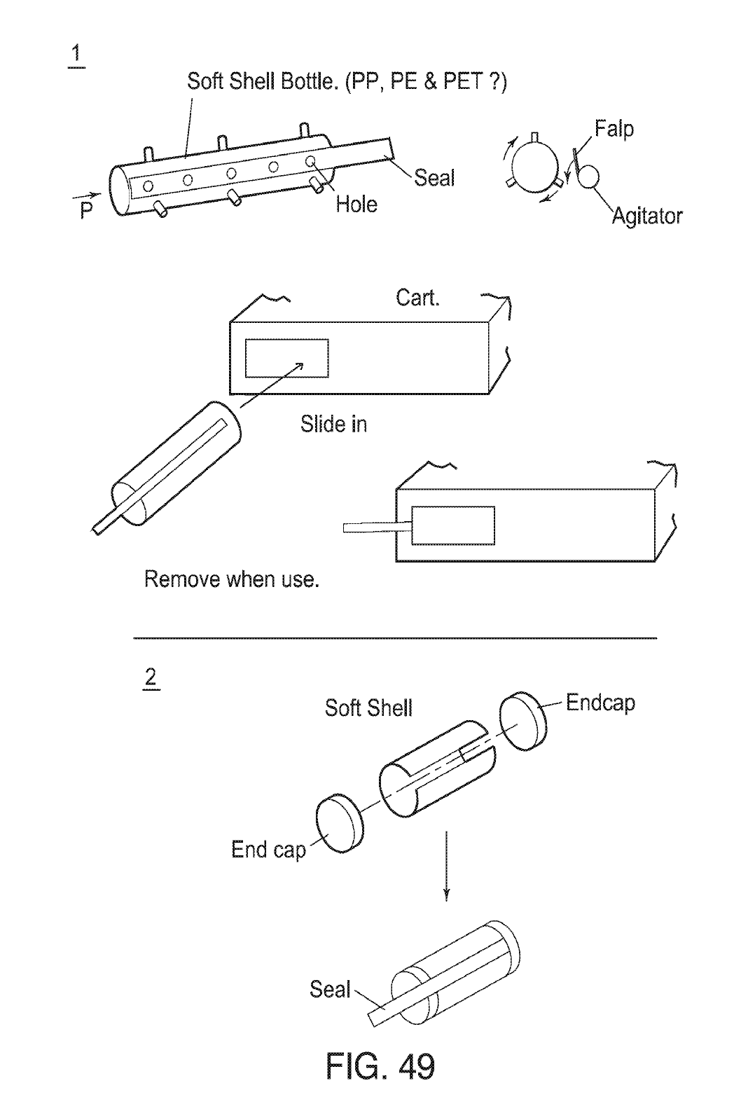

The soft shell bottle is illustrated by FIG. 49, Panel (1) shows a bottle having a substantially cylindrical shape. The body has a plurality of holes, where the holes are covered with a seal. The body of the bottle also has a plurality of protrusions which are adapted to interact with the flaps of an agitator. The bottle can be inserted into a toner cartridge and the seal covering the holes on the body of the bottle can be removed when the cartridge is to be used. Panel (2) shows the bottle equipped with end caps and a seal.

1. A method for sealing a toner hopper of a printer cartridge, the method comprising:
accessing an internal area of the printer cartridge;
disposing a seal over a toner opening port of the toner hopper; and
affixing the seal on the toner hopper.

2. The method of claim 1 wherein the seal is a film.

3. The method of claim 1, wherein the seal comprises a tab.

4. The method of claim 3, further comprising attaching the tab to an agitator in the toner hopper.

5. The method of claim 1, further comprising affixing a gasket to the perimeter of the toner opening port of the toner hopper.

6. The method of claim 1, further comprising affixing the seal to the gasket.

7. The method of claim 6, wherein the gasket includes at least one adhesive layer.

8. The method of claim 1, further comprising affixing a gasket to the perimeter of the top of a bottom vessel of a toner hopper.

9. The method of claim 1, wherein the internal area of the toner cartridge is accessed by cutting a hole in a wall of the printer cartridge.

10. The method of claim 1, wherein the seal is affixed with an adhesive.

11. The method of claim 1, wherein the seal is affixed with heat.

12. The method of claim 9, comprising removing debris created by cutting the hole.

13. The method of claim 9, wherein the hole is made in an optimal position.

14. The method of claim 13, wherein the optimal position is a wall of the printer cartridge adjacent to the toner opening port of the toner hopper.

15. The method of claim 1, wherein the seal is made of anti-static material.

16. The method of claim 1, further comprising disposing the seal over the toner opening of the toner hopper, and on top of a doctor blade and a retaining blade.

17. The method of claim 16, wherein the seal comprises a pull tab.

18. A method for replacing a chip for an image forming device, the method comprising:
accessing a chip by removing the fin;
replacing the chip; and
securing the chip.

19. A method of replacing a bag of toner in a toner hopper, the method comprising:
accessing an internal area of the printer hopper;
removing the bag of toner; and
inserting a replacement bag of toner.

20. The method of claim 19, further comprising filling the replacement bag of toner with toner.
